(19) United States
(12) Patent Application Publication
(10) Pub. No.: US 2026/0250464 A1
(43) Pub. Date: Aug. 27, 2026

(54) POLYSILOXANE FOAM COMPOSITIONS AND METHODS RELATED THERETO

(71) Applicant: Nusil Technology LLC, Carpinteria, CA (US)

(72) Inventors: Matthew Kihara, Carpinteria, CA (US); Dela Judith Hatfield Morgan, Carpinteria, CA (US); James Jared lan Cox, Carpinteria, CA (US); Jeffrey Richard Carmichael, Carpinteria, CA (US); Jianhua Liu, Carpinteria, CA (US)

(21) Appl. No.: 18/994,324

(22) PCT Filed: Jul. 28, 2023
(86) PCT No.: PCT/US2023/028925

§ 371 Date: Jan. 14, 2025

Related U.S. Application Data
(60) Provisional application No. 63/393,081, filed on Jul. 28, 2022.

(51) Int. Cl. C08G 77/08; C08G 77/20; C08G 101/00; C08J 9/00; C08J 9/06; C08J 9/14; C08K 9/06

(52) U.S. Cl. CPC C08G 77/08; C08G 77/20; C08J 9/0052; C08J 9/0061; C08J 9/06; C08J 9/14; C08K 9/06; C08G 2101/00; C08J 2201/022; C08J 2201/026; C08J 2201/052; C08J 2203/184; C08J 2205/04; C08J 2383/07; C08J 2425/06; C08J 2483/07

(57) ABSTRACT

Described is a curable organopolysiloxane foam-forming composition that can be used to produce an organopolysiloxane foam. The curable organopolysiloxane foam-forming composition contains a particle containing a platinum group catalyst and a thermoplastic polymer. The thermoplastic polymer shields the other components in the curable organopolysiloxane foam-forming composition from the platinum group catalyst. As such, when sufficient heat is applied the thermoplastic polymer softens and/or melts, which exposes the platinum group catalyst to the other components to start the foam making process.

### CROSS-REFERENCE TO RELATED APPLICATIONS

This application claims the benefit of U.S. Application No. 63/393,081, filed Jul. 28, 2022, the contents of which are incorporated herein by reference in their entirety.

### FIELD OF INVENTION

This disclosure relates to a foam forming polysiloxane composition and a resulting polysiloxane foam composition. The disclosure also relates to a method of how to make and use such a foam forming polysiloxane composition and resulting polysiloxane foam composition.

### BACKGROUND

In order to produce foam certain types of compositions, contact between a curable component contained in the composition and a catalyst is sometimes necessary. For example, in the case of a hydrosilylation reaction-curable organopolysiloxane composition, the curable component in the composition is crosslinked by a hydrosilylation reaction catalyst such as a platinum-group catalyst. However, curing begins when the catalyst and the curable component come into contact, so it is necessary to prevent the catalyst and the curable component from coming into contact with one another during storage, for example, until curing is required. When used in combination with a blowing agent, such a composition can produce a foam. A conventional silicone foam composition involves hydrogen gas (H₂) formed in-situ as a reaction between a silicone hydride and a blowing agent catalyzed by Pt. This reaction starts immediately once all ingredients of the composition (typically in multiple parts such as Part A & Part B) are mixed together. The hydrogen gas may be able to escape prior to the curing step of the parts or devices manufactured. This lack of control in the process on the H₂ generation typically causes issues such as less consistency of devices, batch-by-batch variations, and inhomogeneity when scaling up.

Thus, there is a need in the art for improved compositions, such as one-component compositions, to produce foams. Such a composition, foam, and methods related thereto are disclosed herein.

### SUMMARY OF THE INVENTION

Disclosed herein is a curable organopolysiloxane foam-forming composition. The curable organopolysiloxane foam-forming composition comprises (A) 100 parts by weight of an organopolysiloxane represented by the average unit formula: RₐSiO_{(4-a)/2}, wherein R is a substituted or unsubstituted monovalent hydrocarbon group, and “a” is a number from 1.0 to 2.4, and having at least an average of 1.5 alkenyl groups in a molecule. The curable organopolysiloxane foam-forming composition also comprises (B) from 3 to 70 parts by weight an organopolysiloxane having at least an average of 1.5 silicon-bonded hydrogen atoms in a molecule. The curable organopolysiloxane foam-forming composition also comprises (C) from 0.1 to 50 parts of a blowing agent. The curable organopolysiloxane foam-forming composition also comprises (D) from 0.00001 to 20 parts of a particle comprising: i. a platinum-group catalyst; and ii. a molecular weight controlled thermoplastic polymer having a T_{g} or softening temperature of at least 20° C. selected from the group consisting of: 1. polystyrene or a co-polymer thereof having a M_{w} from about 500 g/mol to about 30,000 g/mol, and a polydispersity index (PDI) of less than 2; 2. polymethylmethacrylate or a co-polymer thereof having a M_{w} from about 500 g/mol to about 30,000 g/mol, and a PDI of less than 2; and 3. polyacrylonitrile or a co-polymer thereof having a M_{w} from about 500 g/mol to about 30,000 g/mol, and a PDI of less than 2; wherein the platinum-group catalyst is fully encapsulated within the thermoplastic polymer. The curable organopolysiloxane foam-forming composition allows an organopolysiloxane foam to be produced in a controlled fashion.

Also disclosed herein is an organopolysiloxane foam. The organopolysiloxane foam can be produced from the curable organopolysiloxane foam-forming composition disclosed herein. The organopolysiloxane foam contains a molecular weight controlled thermoplastic polymer having a T_{g} or softening temperature of at least 20° C. dispersed throughout organopolysiloxane foam, wherein the molecular weight controlled thermoplastic polymer is selected from the group consisting of: a) polystyrene or a co-polymer thereof having a M_{w} from about 500 g/mol to about 30,000 g/mol, and a polydispersity index (PDI) of less than 2; b) polymethylmethacrylate or a co-polymer thereof having a M_{w} from about 500 g/mol to about 30,000 g/mol, and a PDI of less than 2; and c) polyacrylonitrile or a co-polymer thereof having a M_{w} from about 500 g/mol to about 30,000 g/mol, and a PDI of less than 2.

Also disclosed herein is a method of producing an organopolysiloxane foam comprising the steps of: a) providing the curable organopolysiloxane foam-forming composition disclosed herein; and b) heating the curable organopolysiloxane foam-forming composition to a temperature effective to soften or melt the thermoplastic polymer to release the platinum-group catalyst, thereby promoting the reaction that produces the organopolysiloxane foam.

Additional advantages will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### DETAILED DESCRIPTION

The present invention can be understood more readily by reference to the following detailed description of the invention and the examples included therein.

Before the present particles, compositions, articles, systems, devices, and/or methods are disclosed and described, it is to be understood that they are not limited to specific methods unless otherwise specified, or to particular reagents unless otherwise specified, as such may, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

### A. Definitions

As used herein, nomenclature for compounds can be given using common names as well as names assigned by the International Union of Pure and Applied Chemistry (IUPAC), Chemical Abstracts Service (CAS) recommendations for nomenclature, hereby incorporated herein by reference. One of skill in the art can readily ascertain the structure of a compound and if given a name by systemic reduction of the compound structure using naming conventions.

As used in the specification and the appended claims, the singular forms “a,” “an,” and “the” include plural referents unless the context clearly dictates otherwise.

Ranges can be expressed herein as from “about” one particular value, and/or to “about” another particular value. When such a range is expressed, a further aspect includes from the one particular value and/or to the other particular value. Similarly, when values are expressed as approximations, by use of the antecedent “about,” it will be understood that the particular value forms a further aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

References in the specification and concluding claims to parts by weight of a particular element or component denotes the weight relationship between the element or component and any other elements or components or article for which a part by weight is expressed. Thus, in a composition comprising 100 parts by weight of component X and from 9 to 40 parts by weight component Y, X and Y are present at a weight ratio of 100:9-40 or 0.09-0.4, and are present in such ratio regardless of whether additional components are contained in the composition.

Additionally, references in the specification and concluding claims to molar ratios of a particular element or component denotes the molar relationship between the element or component and any other elements or components in the composition or article for which a molar ratio is expressed. Thus, in a composition containing five moles of component X and two moles component Y, X and Y are present at a molar ratio of 5:2 or 5/2 or 2.5 and are present in such ratio regardless of whether additional components are contained in the composition. A weight percent (wt %) of a component, unless specifically stated to the contrary, is based on total weight of the formulation or composition in which the component is included.

As used herein, the terms “optional” or “optionally” means that a subsequently described event or circumstance can or cannot occur, and that the description includes instances where said event or circumstance occurs and instances where it does not.

A polydispersity index (PDI) as referred to herein is, as in conventional polymer chemistry, a weight-average molecular weight (M_{w}) divided by a number-average molecular weight (Mₙ), and is commonly expressed as: PDI=M_{w}/Mₙ.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow, plain meaning derived from grammatical organization or punctuation, and number or type of embodiments described in the specification.

Disclosed are components to be used to make the particles and compositions disclosed herein as well as what to be used within the methods disclosed herein. These and other compounds are disclosed herein, and it is understood that when combinations, subsets, interactions, groups, etcetera, of these materials are disclosed that while specific reference of each various individual and collective combinations and permutation of these components cannot be explicitly disclosed, each is specifically contemplated and described herein. For example, if a particular silicone composition is disclosed and discussed and a number of modifications that can be made to a number of compounds including the silicone compositions are discussed, specifically contemplated is each and every combination and permutation of the composition and modifications that are possible unless specifically indicated to the contrary. Thus, if a class of compounds A, B, and C are disclosed as well as a class of silicone compositions D, E, and F and an example of a particle or composition, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using silicone compositions. Thus, if there are a variety of additional steps that can be performed, it is understood that each of these additional steps can be performed with any specific embodiment or combination of embodiments of the methods of the invention.

### B. Curable Organopolysiloxane Foam-Forming Composition

Organopolysiloxane foams, mainly due to the forming structure and low density, can be useful in a number of applications, including but not limited to, gasketing, medical devices, repairs, shock-absorbing materials, and thermal insulating or high heat-insulating materials.

An organopolysiloxane foam can be formed from a curable organopolysiloxane foam-forming composition disclosed herein. The components in the curable organopolysiloxane foam-forming composition are mixed and the foam forming process takes place by exposing the a platinum-group catalyst to the rest of the components in the curable organopolysiloxane foam-forming composition, which triggers the reaction that forms the organopolysiloxane foam over a period of time. The organopolysiloxane foam forms when hydrogen gas (H₂) is generated in-situ in the reaction foam forming process. Such a reaction and foaming process starts immediately once the components are exposed to the platinum-group catalyst.

The curable organopolysiloxane foam-forming composition disclosed herein comprises a particle comprising: i. a platinum-group catalyst; and ii. a molecular weight controlled thermoplastic polymer having a T_{g} or softening temperature of at least 20° C. selected from the group consisting of: 1. polystyrene or a co-polymer thereof having a M_{w} from about 500 g/mol to about 30,000 g/mol, and a polydispersity index (PDI) of less than 2; 2. polymethylmethacrylate or a co-polymer thereof having a M_{w} from about 500 g/mol to about 30,000 g/mol, and a PDI of less than 2; and 3. polyacrylonitrile or a co-polymer thereof having a M_{w} from about 500 g/mol to about 30,000 g/mol, and a PDI of less than 2; wherein the platinum-group catalyst is fully encapsulated within the thermoplastic polymer. As such, the platinum-group catalyst is shielded from the other components in the curable organopolysiloxane foam-forming composition until the molecular weight controlled thermoplastic polymer is softened or melted away from around the platinum-group catalyst by an increase in temperature. The particle disclosed herein adds control in the H₂ generation process, which overcomes the processing barriers in conventional organopolysiloxane foam compositions. Thus, the curable organopolysiloxane foam-forming composition disclosed herein can be stored for an extended period of time without inadvertently reacting. That is, during storage, the curable organopolysiloxane foam-forming composition disclosed herein is kept at a low enough temperature to prevent the thermoplastic polymer from softening or melting such that the platinum-group catalyst becomes exposed to the other components of the curable organopolysiloxane foam-forming composition.

In one aspect, the disclosed curable organopolysiloxane foam-forming composition herein can be a one-component curable organopolysiloxane foam-forming composition. In another aspect, the disclosed curable organopolysiloxane foam-forming composition herein can be a two-component or multiple-component curable organopolysiloxane foam-forming composition.

Disclosed herein is a curable organopolysiloxane foam-forming composition comprising:
(A) 100 parts by weight of an organopolysiloxane represented by the average unit formula:

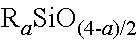

wherein, R is a substituted or unsubstituted monovalent hydrocarbon group, and “a” is a number from 1.0 to 2.4, and having at least an average of 1.5 alkenyl groups in a molecule;
(B) from 1 to 70 parts by weight an organopolysiloxane having at least an average of 1.5 silicon-bonded hydrogen atoms in a molecule;
(C) from 0.1 to 50 parts by weight of a blowing agent; and
(D) from 0.00001 to 20 parts by weight of a particle comprising:
   i. a platinum-group catalyst; and
   ii. a molecular weight controlled thermoplastic polymer having a T_{g} or softening temperature of at least 20° C. selected from the group consisting of:
      1. polystyrene or a co-polymer thereof having a M_{w} from about 500 g/mol to about 30,000 g/mol, and a polydispersity index (PDI) of less than 2;
      2. polymethylmethacrylate or a co-polymer thereof having a M_{w} from about 500 g/mol to about 30,000 g/mol, and a PDI of less than 2; and
      3. polyacrylonitrile or a co-polymer thereof having a M_{w} from about 500 g/mol to about 30,000 g/mol, and a PDI of less than 2;
         wherein the platinum-group catalyst is fully encapsulated within the thermoplastic polymer.

In one aspect, the curable organopolysiloxane foam-forming composition can further comprise: (E) more than 0 to 100 parts by weight of a silicone resin, wherein the silicone resin is different than component (A).

In one aspect, the curable organopolysiloxane foam-forming composition can further comprise: (F) more than 0 to 150 parts by weight of a silicone base comprising a silicone polymer comprising at least one alkenyl group, wherein the silicone base is different than component (A). For example, the curable organopolysiloxane foam-forming composition can further comprise: (E) more than 0 to 100 parts by weight of a silicone resin, wherein the silicone resin is different than component (A), and (F) more than 0 to 150 parts by weight of a silicone base comprising a silicone polymer comprising at least one alkenyl group, wherein the silicone base is different than component (A). It is noted that components (E) and/or (F) can fall within the scope of component (A) but are still considered to be its own components. Thus, for example, a curable organopolysiloxane foam-forming composition that comprises components (E) has two distinguishable components (A) and (E) even if component (E) theoretically falls within the scope of component (A).

In one aspect, the curable organopolysiloxane foam-forming composition can further comprise (G) more than 0 parts to 100 parts by weight of a non-functional fluid.

In one aspect, the curable organopolysiloxane foam-forming composition can further comprise from more than 0 parts to 10 parts by weight of a reaction inhibitor.

In one aspect, the curable organopolysiloxane foam-forming composition can further comprise from more than 0 parts to 150 parts by weight of a filler.

In one aspect, the curable organopolysiloxane foam-forming composition comprises:
(A) 100 parts by weight of an organopolysiloxane represented by the average unit formula:

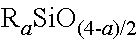

wherein, R is a substituted or unsubstituted monovalent hydrocarbon group, and “a” is a number from 1.0 to 2.4, and having at least an average of 1.5 alkenyl groups in a molecule;
(B) from 10 to 30 parts by weight an organopolysiloxane having at least an average of 1.5 silicon-bonded hydrogen atoms in a molecule;
(C) from 5 to 20 parts by weight of a blowing agent;
(D) from 0.05 to 8 parts by weight of a particle comprising:
   i. a platinum-group catalyst; and
   ii. a molecular weight controlled thermoplastic polymer having a T_{g} or softening temperature of at least 20° C. selected from the group consisting of:
      1. polystyrene or a co-polymer thereof having a M_{w} from about 500 g/mol to about 30,000 g/mol, and a polydispersity index (PDI) of less than 2;
      2. polymethylmethacrylate or a co-polymer thereof having a M_{w} from about 500 g/mol to about 30,000 g/mol, and a PDI of less than 2; and
      3. polyacrylonitrile or a co-polymer thereof having a M_{w} from about 500 g/mol to about 30,000 g/mol, and a PDI of less than 2;
wherein the platinum-group catalyst is fully encapsulated within the thermoplastic polymer;
(E) more than 0 to 60 parts by weight of a silicone resin, wherein the silicon resin is different than component (A); and
(G) more than 0 to 100 parts by weight of a non-functional fluid.

In another aspect, the curable organopolysiloxane foam-forming composition comprises:
(A) 100 parts by weight of an organopolysiloxane represented by the average unit formula:

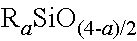

wherein, R is a substituted or unsubstituted monovalent hydrocarbon group, and “a” is a number from 1.0 to 2.4, and having at least an average of 1.5 alkenyl groups in a molecule;
(B) from 5 to 30 parts by weight an organopolysiloxane having at least an average of 1.5 silicon-bonded hydrogen atoms in a molecule;
(C) from 0.1 to 50 parts by weight of a blowing agent; and
(D) from 0.05 to 8 parts by weight of a particle comprising:
   i. a platinum-group catalyst; and
   ii. a molecular weight controlled thermoplastic polymer having a T_{g} or softening temperature of at least 20° C. selected from the group consisting of:
      1. polystyrene or a co-polymer thereof having a M_{w} from about 500 g/mol to about 30,000 g/mol, and a polydispersity index (PDI) of less than 2;
      2. polymethylmethacrylate or a co-polymer thereof having a M_{w} from about 500 g/mol to about 30,000 g/mol, and a PDI of less than 2; and
      3. polyacrylonitrile or a co-polymer thereof having a M_{w} from about 500 g/mol to about 30,000 g/mol, and a PDI of less than 2;
wherein the platinum-group catalyst is fully encapsulated within the thermoplastic polymer;
(F) 10 to 40 parts by weight of a silicone base comprising a silicone polymer comprising at least one alkenyl group, wherein the silicone base is different than component (A); and
(G) more than 0 to 100 parts by weight of a non-functional fluid.
   i. Component (A)

The curable organopolysiloxane foam-forming composition comprises (A) 100 parts by weight of an organopolysiloxane represented by the average unit formula:

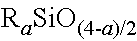

wherein, R is a substituted or unsubstituted monovalent hydrocarbon group, and “a” is a number from 1.0 to 2.4, and having at least an average of 1.5 alkenyl groups in a molecule.

In the RₐSiO_{(4-a)/2} formula, R is a substituted or unsubstituted monovalent hydrocarbon group, and examples of this monovalent hydrocarbon group include alkyl groups such as methyl groups, ethyl groups, propyl groups, butyl groups, pentyl groups, and hexyl groups; alkenyl groups such as vinyl groups, allyl groups, butenyl groups, pentenyl groups, hexenyl groups, and heptenyl groups; aryl groups such as phenyl groups, tolyl groups, and xylyl groups; aralkyl groups such as benzyl groups and phenethyl groups; and halogenated alkyl groups such as 3-chloropropyl groups and 3,3,3-trifluoropropyl groups. For example, at least an average of 1.5 groups of R in a molecule are alkenyl groups such as those described above. Vinyl groups and hexenyl groups can be the alkenyl groups. Methyl groups and phenyl groups can be silicon-bonded groups other than the alkenyl groups.

In the RₐSiO_{(4-a)/2} formula above, “a” is a number from 1.0 to 2.4. Examples of molecular structures of such component (A) include a straight chain structure, a partially branched straight chain structure, a branched chain structure, a reticulated structure, and a dendritic structure. Component (A) may be a mixture of two or more types of organopolysiloxanes having these molecular structures. That is, a may be either 1≤a<2 or 2≤a<2.4. A viscosity at 25° C. of the organopolysiloxane is not limited to but can be within the range of from 50 to 1,000,000 mPa·s, such as within the range of from 100 to 500,000 mPa·s.

Examples of the organopolysiloxane of formula RₐSiO_{(4-a)/2} include, but are not limited to, dimethylsiloxane-methylvinylsiloxane copolymers capped at both molecular terminals with trimethylsiloxy groups, methylvinylpolysiloxanes capped at both molecular terminals with trimethylsiloxy groups, methylvinylsiloxane-methylphenylsiloxane copolymers capped at both molecular terminals with trimethylsiloxy groups, dimethylsiloxane-methylvinylsiloxane-methylphenylsiloxane copolymers capped at both molecular terminals with trimethylsiloxy groups, dimethylpolysiloxanes capped at both molecular terminals with dimethylvinylsiloxy groups, methylvinylpolysiloxanes capped at both molecular terminals with dimethylvinylsiloxy groups, methylphenylpolysiloxanes capped at both molecular terminals with dimethylvinylsiloxy groups, dimethylsiloxane-methylvinylsiloxane copolymers capped at both molecular terminals with dimethylvinylsiloxy groups, methylvinylsiloxane-methylphenylsiloxane copolymers capped at both molecular terminals with dimethylvinylsiloxy groups, methylvinylsiloxane-diphenylsiloxane copolymers capped at both molecular terminals with dimethylvinylsiloxy groups, dimethylvinylsiloxane-diphenylsiloxane copolymers capped at both molecular terminals with dimethylvinylsiloxy groups, methylvinylpolysiloxanes capped at one molecular terminal with a trimethylsiloxy group and the other molecular terminal with a dimethylvinylsiloxy group, dimethylsiloxane-methylvinylsiloxane copolymers capped at one molecular terminal with a trimethylsiloxy group and the other molecular terminal with a dimethylvinylsiloxy group, organopolysiloxanes comprising a unit represented by the formula: R₃SiO_{1/2} and a unit represented by the formula: SiO_{4/2}, organopolysiloxanes comprising a unit represented by the formula: RSiO_{3/2}, organopolysiloxanes comprising a unit represented by the formula: R₂SiO_{2/2} and a unit represented by the formula: RSiO_{3/2}, organopolysiloxanes comprising a unit represented by the formula: R₂SiO_{2/2}, a unit represented by the formula: RSiO_{3/2}, and a unit represented by the formula: SiO_{4/2}, and mixtures of two or more types of these organopolysiloxanes. R in the formulas above is a substituted or unsubstituted monovalent hydrocarbon group as described above.

As the organopolysiloxane of formula RₐSiO_{(4-a)/2}, it is also contemplated to use an organopolysiloxane mixture with an average number of 1.5 alkenyl groups in a molecule by mixing an organopolysiloxane listed above having at least 2 alkenyl groups in a molecule and an organopolysiloxane listed below having no alkenyl groups or having less than 2 alkenyl groups in a molecule. Examples of such an organopolysiloxane having no alkenyl groups or having less than 2 alkenyl groups in a molecule include dimethylpolysiloxanes capped at one molecular terminal with a dimethylvinylsiloxy group and the other molecular terminal with a trimethylsiloxy group, methylphenylpolysiloxanes capped at one molecular terminal with a dimethylvinylsiloxy group and the other molecular terminal with a trimethylsiloxy group, dimethylsiloxane-methylvinylsiloxane copolymers capped at both molecular terminals with trimethylsiloxy groups and having 1 vinyl group on the molecular side chains, dimethylpolysiloxanes capped at both molecular terminals with trimethylsiloxy groups, and methylphenylpolysiloxanes capped at both molecular terminals with trimethylsiloxy groups.

In one aspect, the organopolysiloxane in component (A) is an alkenyl-terminated organopolysiloxane, an alkenyl-pendant organopolysiloxane, or an alkenyl-terminated and alkenyl-pendant organopolysiloxane. For example, the organopolysiloxane in component (A) can be an alkenyl-terminated organopolysiloxane. In another aspect, the organopolysiloxane in component (A) can be an alkenyl-pendant organopolysiloxane. In yet another aspect, the organopolysiloxane in component (A) can be an alkenyl-terminated and alkenyl-pendant organopolysiloxane.

In one aspect, the organopolysiloxane in component (A) can comprise at least two organopolysiloxanes having different molecular weights. For example, the organopolysiloxane in component (A) can comprise at least three organopolysiloxanes having different molecular weights. In another example, the organopolysiloxane in component (A) can comprise at least four organopolysiloxanes having different molecular weights. The at least two, three, or four organopolysiloxanes do not encompass components (E) and/or (F) when components (E) and/or (F) are present. For example, when the curable organopolysiloxane foam-forming composition has an organopolysiloxane in component (A) that comprises at least two organopolysiloxanes having different molecular weights and component (E), then the curable organopolysiloxane foam-forming composition comprises three components in this respect: 1. an organopolysiloxane component (A) having one molecular weight (M_{w}); 2. an organopolysiloxane component (A) having a different M_{w} than (1.); and 3. component (E).

In one aspect, the organopolysiloxane in component (A) or each of the organopolysiloxanes in component (A) can have a M_{w} from about 500 g/mol to about 300,000 g/mol, a M_{w} from about 500 g/mol to about 250,000 g/mol, a M_{w} from about 500 g/mol to about 300,000 g/mol, a M_{w} from about 500 g/mol to about 200,000 g/mol, a M_{w} from about 500 g/mol to about 150,000 g/mol, a M_{w} from about 500 g/mol to about 100,000 g/mol, a M_{w} from about 500 g/mol to about 90,000 g/mol, a M_{w} from about 500 g/mol to about 80,000 g/mol, a M_{w} from about 500 g/mol to about 70,000 g/mol, a M_{w} from about 500 g/mol to about 60,000 g/mol, a M_{w} from about 500 g/mol to about 50,000 g/molm, a M_{w} from about 500 g/mol to about 40,000 g/mol, a M_{w} from about 500 g/mol to about 35,000 g/mol, a M_{w} from about 500 g/mol to about 30,000 g/mol, a M_{w} from about 500 g/mol to about 25,000 g/mol, a M_{w} from about 500 g/mol to about 20,000 g/mol, a M_{w} from about 500 g/mol to about 15,000 g/mol, a M_{w} from about 500 g/mol to about 10,000 g/mol, a M_{w} from about 10,000 g/mol to about 300,000 g/mol, a M_{w} from about 15,000 g/mol to about 300,000 g/mol, a M_{w} from about 25,000 g/mol to about 300,000 g/mol, a M_{w} from about 30,000 g/mol to about 300,000 g/mol, a M_{w} from about 35,000 g/mol to about 300,000 g/mol, a M_{w} from about 40,000 g/mol to about 300,000 g/mol, a M_{w} from about 45,000 g/mol to about 300,000 g/mol, a M_{w} from about 50,000 g/mol to about 300,000 g/mol, a M_{w} from about 60,000 g/mol to about 300,000 g/mol, a M_{w} from about 70,000 g/mol to about 300,000 g/mol, a M_{w} from about 80,000 g/mol to about 300,000 g/mol, a M_{w} from about 90,000 g/mol to about 300,000 g/mol, a M_{w} from about 100,000 g/mol to about 300,000 g/mol, a M_{w} from about 150,000 g/mol to about 300,000 g/mol, a M_{w} from about 200,000 g/mol to about 300,000 g/mol, a M_{w} from about 10,000 g/mol to about 30,000 g/mol, a M_{w} from about 10,000 g/mol to about 50,000 g/mol, a M_{w} from about 30,000 g/mol to about 70,000 g/mol, a M_{w} from about 50,000 g/mol to about 90,000 g/mol, a M_{w} from about 70,000 g/mol to about 120,000 g/mol, a M_{w} from about 50,000 g/mol to about 150,000 g/mol, or a M_{w} from about 80,000 g/mol to about 150,000 g/mol. Any combination of the values above can be used for when the organopolysiloxane in component (A) comprises at least two, three, or four organopolysiloxanes having different molecular weights.

For example, when the organopolysiloxane in component (A) comprises at least two organopolysiloxanes having different molecular weights a first organopolysiloxane can have a M_{w} from about 50,000 g/mol to about 150,000 g/mol, and second organopolysiloxane can have a M_{w} from about 10,000 g/mol to about 50,000 g/mol. If a third organopolysiloxane is present can have a M_{w} from about 500 g/mol to about 10,000 g/mol.

ii. Component (B)

The curable organopolysiloxane foam-forming composition comprises (B) from 3 to 70 parts by weight an organopolysiloxane having at least an average of 1.5 silicon-bonded hydrogen atoms in a molecule.

Component (B) in the curable organopolysiloxane composition is a crosslinking agent and is an organopolysiloxane having at least an average of 1.5 silicon-bonded hydrogen atoms in a molecule. For example, the organopolysiloxane can have least an average of 2 silicon-bonded hydrogen atoms in a molecule. The bonding sites of the silicon-bonded hydrogen atoms can be molecular terminals, molecular side chains, or molecular terminals and molecular side chains. Examples of silicon-bonded groups other than hydrogen atoms include substituted or unsubstituted monovalent hydrocarbon groups such as methyl groups, ethyl groups, propyl groups, butyl groups, pentyl groups, and hexyl groups; alkenyl groups such as vinyl groups, allyl groups, butenyl groups, pentenyl groups, hexenyl groups, and heptenyl groups; aryl groups such as phenyl groups, tolyl groups, and xylyl groups; aralkyl groups such as benzyl groups and phenethyl groups; and halogenated alkyl groups such as 3-chloropropyl groups and 3,3,3-trifluoropropyl groups as well as alkoxy silyl alkyl groups such as trimethoxysilylethyl groups, methyldimethoxysilylethyl groups, triethoxysilylethyl groups, and trimethoxysilylpropyl groups; alkoxy groups such as methoxy groups, ethoxy groups, propoxy groups, and glycidoxy alkyl groups such as glycidoxypropyl groups and glycidoxybutyl groups. Examples of molecular structures of the organopolysiloxane having at least an average of 1.5 silicon-bonded hydrogen atoms in a molecule include a straight chain structure, a partially branched straight chain structure, a branched chain structure, a reticulated structure, and a dendritic structure. The organopolysiloxane having at least an average of 1.5 silicon-bonded hydrogen atoms in a molecule can be a mixture of two or more types of organopolysiloxanes having these molecular structures. A viscosity at 25° C. of the organopolysiloxane having at least an average of 1.5 silicon-bonded hydrogen atoms in a molecule can be within the range of from 1 to 500,000 mPa·s, such as within the range of from 1 to 1,000 mPa·s.

Examples of the organopolysiloxane for the organopolysiloxane having at least an average of 1.5 silicon-bonded hydrogen atoms in a molecule include, but are not limited to, methylhydrogenpolysiloxanes capped at both molecular terminals with trimethylsiloxy groups, dimethylsiloxane-methylhydrogensiloxane copolymers capped at both molecular terminals with trimethylsiloxy groups, methylhydrogensiloxane-methylphenylsiloxane copolymers capped at both molecular terminals with trimethylsiloxy groups, dimethylsiloxane-methylhydrogensiloxane-methylphenylsiloxane copolymers capped at both molecular terminals with trimethylsiloxy groups, dimethylpolysiloxanes capped at both molecular terminals with dimethylhydrogensiloxy groups, methylhydrogenpolysiloxanes capped at both molecular terminals with dimethylhydrogensiloxy groups, dimethylsiloxane-methylhydrogensiloxane copolymers capped at both molecular terminals with dimethylhydrogensiloxy groups, dimethylsiloxane-methylphenylsiloxane copolymers capped at both molecular terminals with dimethylhydrogensiloxy groups, dimethylsiloxane-methylhydrogensiloxane-methylphenylsiloxane copolymers capped at both molecular terminals with dimethylhydrogensiloxy groups, organopolysiloxanes comprising a unit represented by the formula: R′₃SiO_{1/2} and a unit represented by the formula: SiO_{4/2}, organopolysiloxanes comprising a unit represented by the formula: R′_{3/2}, organopolysiloxanes comprising a unit represented by the formula: R′₂SiO_{2/2} and a unit represented by the formula: R′SiO_{3/2}, organopolysiloxanes comprising a unit represented by the formula: R′₂SiO_{2/2}, a unit represented by the formula: R′SiO_{3/2}, and a unit represented by the formula: SiO_{4/2}, methylhydrogensiloxane-methyl(trimethoxysilylethyl) siloxane copolymers capped at both molecular terminals with trimethylsiloxy groups, methylhydrogensiloxane-methyl(trimethoxysilylethyl) siloxane-methyl (3-glycidoxypropyl) siloxane copolymers capped at both molecular terminals with trimethylsiloxy groups, dimethylsiloxane-methylhydrogensiloxane-methyl(trimethoxysilylethyl) siloxane copolymers capped at both molecular terminals with trimethylsiloxy groups, dimethylsiloxane-methylhydrogensiloxane-methyl(trimethoxysilylethyl) siloxane-methyl (3-glycidoxypropyl) siloxane copolymers capped at both molecular terminals with trimethylsiloxy groups, methylhydrogensiloxane-methyl(triethoxysilylethyl) siloxane copolymers capped at both molecular terminals with trimethylsiloxy groups, methylhydrogensiloxane-methyl(triethoxysilylethyl) siloxane-methyl (3-glycidoxypropyl) siloxane copolymers capped at both molecular terminals with trimethylsiloxy groups, dimethylsiloxane-methylhydrogensiloxane-methyl(trimethoxysilylethyl) siloxane copolymers capped at both molecular terminals with trimethylsiloxy groups, dimethylsiloxane-methylhydrogensiloxane-methyl(triethoxysilylethyl) siloxane-methyl (3-glycidoxypropyl) siloxane copolymers capped at both molecular terminals with trimethylsiloxy groups, and mixtures of two or more types of these organopolysiloxanes. R′ in the formulas above is a substituted or unsubstituted monovalent hydrocarbon group, and examples of this monovalent hydrocarbon group include the alkyl groups, alkenyl groups, aryl groups, aralkyl groups, or halogenated alkyl groups described above. In one aspect, the organopolysiloxane having at least an average of 1.5 silicon-bonded hydrogen atoms in a molecule can be a mixture of an organopolysiloxane having silicon-bonded hydrogen atoms only at both molecular terminals and an organopolysiloxane having at least 3 silicon-bonded hydrogen atoms in a molecule due to the excellent mechanical characteristics—the elongation, in particular—of the cured product formed by the present composition.

In one aspect, the organopolysiloxane in component (B) is a hydride-terminated organopolysiloxane, a hydride-pendant organopolysiloxane, or a hydride-terminated and hydride-pendant organopolysiloxane. For example, the organopolysiloxane in component (B) can be a hydride-terminated organopolysiloxane. In another aspect, the organopolysiloxane in component (B) can be a hydride-pendant organopolysiloxane. In yet another aspect, the organopolysiloxane in component (B) can be a hydride-terminated and hydride-pendant organopolysiloxane.

A content of the organopolysiloxane having at least an average of 1.5 silicon-bonded hydrogen atoms in a molecule can be in an amount such that a quantity of silicon-bonded hydrogen atoms in the organopolysiloxane having at least an average of 1.5 silicon-bonded hydrogen atoms in a molecule is within the range of from 0.05 to 20 mol per 1 mol of alkenyl groups in an organopolysiloxane represented by the average unit formula RₐSiO_{(4-a)/2}, for example within the range of from 0.1 to 20 mol, and such as within the range of from 0.1 to 10 mol.

Component (B) is present from 1 to 70 parts by weight. For example, component (B) can be present from 1 to 50 parts by weight, from 1 to 40 parts by weight, from 1 to 30 parts by weight, from 1 to 25 parts by weight, from 1 to 20 parts by weight, from 1 to 15 parts by weight, from 3 to 70 parts by weight, from 3 to 50 parts by weight, from 3 to 40 parts by weight, from 5 to 40 parts by weight, from 3 to 30 parts by weight, from 3 to 25 parts by weight, from 3 to 20 parts by weight, from 3 to 15 parts by weight, from 5 to 70 parts by weight, from 10 to 70 parts by weight, from 15 to 70 parts by weight, from 20 to 70 parts by weight, from 30 to 70 parts by weight, from 5 to 30 parts by weight, from 10 to 50 parts by weight, or from 10 to 30 parts by weight.

iii. Component (C)

The curable organopolysiloxane foam-forming composition comprises (C) from 0.1 to 50 parts by weight of a blowing agent.

The blowing agent can be a hydroxyl containing compound selected from the group consisting of polyols, monofunctional alcohols, silanol group-containing organosilanes, silanol group-containing organosiloxanes, and water. The blowing agent can also comprise mixtures of such compounds. The hydroxyl groups on blowing agent react with some of the silicon-bonded hydrogen of component (B) described herein to produce hydrogen gas (H₂), which creates the cells in the foam.

When the blowing agent comprises a polyol, it can be an organic alcohol having from 3 to 12 carbon atoms and containing an average of at least two hydroxyl groups per molecule. The carbon chain which makes up the backbone of the polyol may be straight-chained or branched, or may have an aromatic ring to which a hydroxyl group is not directly bonded. Usable polyols include saturated polyhydric alcohols having at least two hydroxy groups per molecule. Saturated polyhydric alcohols are taught, for example by Weise in U.S. Pat. No. 4,871,781, which is incorporated for reference for its teaching regarding saturated polyhydric alcohols as blowing agent. Examples of aliphatic polyhydric alcohols are diols, such as 1,2-ethanediol, 2,3-propanediol, 1,3-propanediol, 1,4-butanediol, 1,5 pentanediol, and 1,6-hexane diol; 1,2,3-propanetriol; 2,2-bis-hydroxymethyl-1-butanol; tetritols, such as erythritol and pentaerythritol (2,2-bis-hydroxymethyl-1,3-propane diol); pentitols, such as arabitol, xylitol, and methylpentitol; hexitols, such as mannitol and sorbitol; and cycloaliphatic polyhydric alcohols such as cyclohexanediols, cyclohexane tirols, and inositol.

In one aspect, the polyol is a diol. Suitable diols include, but are not limited to, 1,2 ethanediol, 1,4-butanediol, 1,5-pentanediol and 1,7-heptanediol. Sufficient polyol is used to produce the necessary amount of hydrogen for the foaming process to produce suitable foams.

When the blowing agent comprises a monofunctional alcohol, it can be an organic alcohol containing 1 to 12 carbon atoms and one hydroxyl group per molecule. The carbon chain which makes up the backbone of the organic alcohol may be straight chained, branched, or may have an aromatic ring to which a hydroxyl group is not directly bonded. This optional monofunctional alcohol differs from the polyol in that the monofunctional alcohol can not contain an average of more than one hydroxyl group per molecule. The amount of optional monofunctional alcohol that is needed to reduce the density of the foam of the present invention varies depending upon the composition of the foam forming composition and the monofunctional alcohol used. Examples of monofunctional alcohols include methanol, ethanol, n-propanol, isopropanol, n-butanol, 2-butanol, tert-butanol, n-octanol, and benzyl alcohol.

When the blowing agent is a silanol group-containing organosilane, it includes, for example, compounds represented by the general formulas (1) and (2):

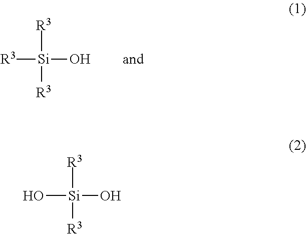

where R³ is a substituted or unsubstituted monovalent hydrocarbon containing no aliphatic unsaturated bonds. R³ may include alkyl groups having 1 to 6 carbon atoms such as a methyl group, an ethyl group and a propyl group; cycloalkyl groups having 6 to 10 carbon atoms such as a cyclohexyl group; aryl groups having 6 to 10 carbon atoms such as a phenyl group and a tolyl group; aralkyl groups having 7 to 12 carbon atoms such as a benzyl group, a 2-phenylethyl group and a 1-phenylpropyl group; and any of these groups where at least one hydrogen atom has been substituted with a halogen atom (e.g. a 3,3,3-trifluoropropyl group). In one aspect, R³ is methyl. The groups represented by R³ s may be all the same or may be different from one another. Such organosilanes are exemplified by the following compounds:

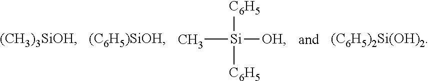

When the blowing agent is a silanol group-containing organosiloxane, it includes, for example, compounds represented by the general formula (3)

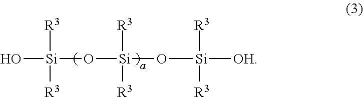

R³ is as defined previously, and a is an integer that from 0 to about 50, preferably about 1 to about 50, and more preferably about 3 to about 20.

When the blowing agent is water, it is added in an amount from about 100 parts per million parts to 1.5 parts by weight by of water based on 100 parts component (A). The use of water as a blowing agent for silicone foams is taught, for example, by Modic in U.S. Pat. No. 4,289,545, which is hereby incorporated for reference for what it teaches regarding the use of water as a blowing agent. The water can added such that there is 0.2:1 to 50:1 moles of silicon-bonded hydrogen in Component (B) per mole of water. For example, the silicon-bonded hydrogen to water ratio can be from 1:1 to 5:1.

Component (C) is present from 0.1 to 50 parts by weight. For example, component (C) can be present from 0.1 to 40 parts by weight, from 0.1 to 30 parts by weight, from 0.1 to 25 parts by weight, from 0.1 to 20 parts by weight, from 0.1 to 15 parts by weight, from 0.5 to 50 parts by weight, from 5 to 50 parts by weight, from 10 to 50 parts by weight, from 15 to 50 parts by weight, from 20 to 50 parts by weight, from 30 to 50 parts by weight, from 0.5 to 40 parts by weight, from 0.5 to 30 parts by weight, from 5 to 40 parts by weight, from 5 to 30 parts by weight, from 3 to 20 parts by weight, or from 5 to 20 parts by weight. Component (C) can be present in an amount such that a quantity of silicon-bonded hydrogen atoms in component (C) is from 0.05 to 20 mol per 1 mol of alkenyl groups in component (A).

iv. Component (D)

The curable organopolysiloxane foam-forming composition comprises (D) from 0.00001 to 20 parts by weight of a particle comprising:
i. a platinum-group catalyst; and
ii. a molecular weight controlled thermoplastic polymer having a T_{g} or softening temperature of at least 20° C. selected from the group consisting of:
   1. polystyrene or a co-polymer thereof having a M_{w} from about 500 g/mol to about 30,000 g/mol, and a polydispersity index (PDI) of less than 2;
   2. polymethylmethacrylate or a co-polymer thereof having a M_{w} from about 500 g/mol to about 30,000 g/mol, and a PDI of less than 2;
   3. polyacrylonitrile or a co-polymer thereof having a M_{w} from about 500 g/mol to about 30,000 g/mol, and a PDI of less than 2;
wherein the platinum-group catalyst is fully encapsulated within the thermoplastic polymer.

The molecular weight controlled thermoplastic polymer used in the disclosed particle has a narrow molecular weight and a narrow polydispersity index (PDI) that allows for lower and more defined activation temperatures when the particle is used in a curable organopolysiloxane composition. It is desired to tailor the activation temperature to specific uses. Also, by having a narrow molecular weight and a narrow PDI the reproducibility of the particle improves, meaning that each batch of particles behave nearly identical with respect to the activation temperature. Having a large PDI (for example above 2) can cause each batch of particles to have significantly different activation temperatures, making the particle less predictable.

The catalyst is a hydrosilylation catalyst. In one aspect, the platinum group catalyst is selected from the group consisting of platinum (Pt), palladium (Pd), ruthenium (Ru), rhodium (Rh), osmium (Os), iridium (Ir), and any combination thereof. For example, the platinum group catalyst can be platinum. In another example, the platinum group catalyst can be palladium. In yet another example, the platinum group catalyst can be ruthenium. In yet another example, the platinum group catalyst can be rhodium. In yet another example, the platinum group catalyst can be osmium. In yet another example, the platinum group catalyst can be iridium. Non-limiting specific hydrosilylation reaction catalysts include platinum black, platinum-supported alumina powders, platinum-supported silica powders, platinum-supported carbon powders, chloroplatinic acids, alcohol solutions of chloroplatinic acids, complexes of platinum and olefin, complexes of platinum and alkenyl siloxanes such as divinyltetramethyldisiloxane, and catalysts prepared by further diluting a complex of platinum and an alkenyl siloxane with an alkenyl siloxane, a siloxane oligomer, or the like; palladium-based catalysts such as tetrakis(triphenylphosphine) palladium; and rhodium-based catalysts.

Encapsulated Pt catalysts developed in WO2021/113470, when formulated into silicone foam compositions, provides physical isolation of Pt catalyst from silicone hydrides and blowing agents, therefore eliminating the H₂ formation during the sample storage and mixing stages. Such compositions typically have a long shelf life and curing-on-demand by the temperature applied. Particularly the encapsulated Pt catalysts with lower and different activation temperatures can be used to fine tune the release of Pt catalyst for hydrogen formation in the foaming process, therefore overcoming processing barriers in conventional silicone compositions, and creating new potential applications for silicone foams.

In one aspect, the particle comprises from about 0.01 wt % to about 50 wt % of the platinum-group catalyst. For example, the particle can comprise from about 0.01 wt % to about 40 wt % of the platinum-group catalyst. In another example, the particle can comprise from about 0.01 wt % to about 30 wt % of the platinum-group catalyst. In yet another example, the particle can comprise from about 0.1 wt % to about 50 wt % of the platinum-group catalyst. In yet another example, the particle can comprise from about 0.1 wt % to about 40 wt % of the platinum-group catalyst. In yet another example, the particle can comprise from about 0.1 wt % to about 30 wt % of the platinum-group catalyst. In yet another example, the particle can comprise from about 0.1 wt % to about 20 wt % of the platinum-group catalyst. In yet another example, the particle can comprise from about 0.1 wt % to about 10 wt % of the platinum-group catalyst. In another example, the particle can comprise from about 1 wt % to about 10 wt % of the platinum-group catalyst. In yet another example, the particle can comprise from about 2 wt % to about 10 wt % of the platinum-group catalyst. In another example, the particle can comprise from about 10 wt % to about 50 wt % of the platinum-group catalyst. In yet another example, the particle can comprise from about 20 wt % to about 50 wt % of the platinum-group catalyst.

In one aspect, the molecular weight controlled thermoplastic polymer can have a T_{g} or softening temperature of at least 30° C. For example, the molecular weight controlled thermoplastic polymer can have a T_{g} or softening temperature of at least 40° C. In another example, the molecular weight controlled thermoplastic polymer can have a T_{g} or softening temperature of at least 50° C. In yet another example, the molecular weight controlled thermoplastic polymer can have a T_{g} or softening temperature of at least 60° C. In yet another example, the molecular weight controlled thermoplastic polymer can have a T_{g} or softening temperature of at least 70° C. In yet another example, the molecular weight controlled thermoplastic polymer can have a T_{g} or softening temperature of at least 80° C. In yet another example, the molecular weight controlled thermoplastic polymer can have a T_{g} or softening temperature of at least 90° C. In yet another example, the molecular weight controlled thermoplastic polymer can have a T_{g} or softening temperature from 20° C. to 100° C. In yet another example, the molecular weight controlled thermoplastic polymer can have a T_{g} or softening temperature from 30° C. to 100° C. C. In yet another example, the molecular weight controlled thermoplastic polymer can have a T_{g} or softening temperature from 30° C. to 180° C. In yet another example, the molecular weight controlled thermoplastic polymer can have a T_{g} or softening temperature from 50° C. to 100° C. In yet another example, the molecular weight controlled thermoplastic polymer can have a T_{g} or softening temperature from 70° C. to 100° C. In yet another example, the molecular weight controlled thermoplastic polymer can have a T_{g} or softening temperature from 20° C. to 80° C. In yet another example, the molecular weight controlled thermoplastic polymer can have a T_{g} or softening temperature from 20° C. to 60° C. In yet another example, the molecular weight controlled thermoplastic polymer can have a T_{g} or softening temperature from 55° C. to 75° C. In yet another example, the molecular weight controlled thermoplastic polymer can have a T_{g} or softening temperature from 75° C. to 95° C.

In one aspect, the molecular weight controlled thermoplastic polymer can have a T_{g} temperature of at least 20° C. For example, the molecular weight controlled thermoplastic polymer can have a T_{g} of at least 40° C. In another example, the molecular weight controlled thermoplastic polymer can have a T_{g} of at least 50° C. In yet another example, the molecular weight controlled thermoplastic polymer can have a T_{g} of at least 60° C. In yet another example, the molecular weight controlled thermoplastic polymer can have a T_{g} of at least 70° C. In yet another example, the molecular weight controlled thermoplastic polymer can have a T_{g} of at least 80° C. In yet another example, the molecular weight controlled thermoplastic polymer can have a T_{g} of at least 90° C. In yet another example, the molecular weight controlled thermoplastic polymer can have a T_{g} from 20° C. to 100° C. In yet another example, the molecular weight controlled thermoplastic polymer can have a T_{g} from 30° C. to 100° C. In yet another example, the molecular weight controlled thermoplastic polymer can have a T_{g} from 30° C. to 180° C. In yet another example, the molecular weight controlled thermoplastic polymer can have a T_{g} from 50° C. to 100° C. In yet another example, the molecular weight controlled thermoplastic polymer can have a T_{g} from 70° C. to 100° C. In yet another example, the molecular weight controlled thermoplastic polymer can have a T_{g} from 20° C. to 80° C. In yet another example, the molecular weight controlled thermoplastic polymer can have a T_{g} from 20° C. to 60° C. In yet another example, the molecular weight controlled thermoplastic polymer can have a T_{g} from 55° C. to 75° C. In yet another example, the molecular weight controlled thermoplastic polymer can have a T_{g} from 75° C. to 95° C.

In one aspect, the molecular weight controlled thermoplastic polymer can have a softening temperature of at least 20° C. For example, the molecular weight controlled thermoplastic polymer can have a softening temperature of at least 40° C. In another example, the molecular weight controlled thermoplastic polymer can have a softening temperature of at least 50° C. In yet another example, the molecular weight controlled thermoplastic polymer can have a softening temperature of at least 60° C. In yet another example, the molecular weight controlled thermoplastic polymer can have a softening temperature of at least 70° C. In yet another example, the molecular weight controlled thermoplastic polymer can have a softening temperature of at least 80° C. In yet another example, the molecular weight controlled thermoplastic polymer can have a softening temperature of at least 90° C. In yet another example, the molecular weight controlled thermoplastic polymer can have a softening temperature from 20° C. to 100° C. In yet another example, the molecular weight controlled thermoplastic polymer can have a softening temperature from 30° C. to 100° C. In yet another example, the molecular weight controlled thermoplastic polymer can have a softening temperature from 30° C. to 180° C. In yet another example, the molecular weight controlled thermoplastic polymer can have a softening temperature from 50° C. to 100° C. In yet another example, the molecular weight controlled thermoplastic polymer can have a softening temperature from 70° C. to 100° C. In yet another example, the molecular weight controlled thermoplastic polymer can have a softening temperature from 20° C. to 80° C. In yet another example, the molecular weight controlled thermoplastic polymer can have a softening temperature from 20° C. to 60° C. In yet another example, the molecular weight controlled thermoplastic polymer can have a softening temperature from 55° C. to 75° C. In yet another example, the molecular weight controlled thermoplastic polymer can have a softening temperature from 75° C. to 95° C.

In one aspect, the molecular weight controlled thermoplastic polymer can have a melting temperature from 20° C. to 180° C. For example, the molecular weight controlled thermoplastic polymer can have a melting temperature from 40° C. to 100° C. In another example, the molecular weight controlled thermoplastic polymer can have a melting temperature from 50° C. to 100° C. In yet another example, the molecular weight controlled thermoplastic polymer can have a melting temperature from 60° C. to 100° C. In yet another example, the molecular weight controlled thermoplastic polymer can have a melting temperature from 30° C. to 90° C. In yet another example, the molecular weight controlled thermoplastic polymer can have a melting temperature from 30° C. to 180° C. In yet another example, the molecular weight controlled thermoplastic polymer can have a melting temperature from 30° C. to 60° C. In yet another example, the molecular weight controlled thermoplastic polymer can have a melting temperature from 60° C. to 90° C. In yet another example, the molecular weight controlled thermoplastic polymer can have a melting temperature from 55° C. to 75° C. In yet another example, the molecular weight controlled thermoplastic polymer can have a melting temperature from 75° C. to 95° C.

In one aspect, the thermoplastic polymer is polystyrene or a co-polymer thereof having a M_{w} from about 500 g/mol to about 30,000 g/mol, and a polydispersity index (PDI) of less than 2. For example, the thermoplastic polymer can be polystyrene or a co-polymer thereof having a M_{w} from about 500 g/mol to about 30,000 g/mol, and a polydispersity index (PDI) of less than 1.8. In another example, the thermoplastic polymer can be polystyrene or a co-polymer thereof having a M_{w} from about 500 g/mol to about 30,000 g/mol, and a polydispersity index (PDI) of less than 1.5. In yet another example, the thermoplastic polymer can be polystyrene or a co-polymer thereof having a M_{w} from about 500 g/mol to about 30,000 g/mol, and a polydispersity index (PDI) of less than 1.2. In yet another example, the thermoplastic polymer can be polystyrene or a co-polymer thereof having a M_{w} from about 500 g/mol to about 30,000 g/mol, and a polydispersity index (PDI) of less than 1.1.

In one aspect, the thermoplastic polymer is polystyrene or a co-polymer thereof having a M_{w} from about 1,000 g/mol to about 15,000 g/mol, and a polydispersity index (PDI) of less than 2. For example, the thermoplastic polymer can be polystyrene or a co-polymer thereof having a M_{w} from about 1,000 g/mol to about 15,000 g/mol, and a polydispersity index (PDI) of less than 1.8. In another example, the thermoplastic polymer can be polystyrene or a co-polymer thereof having a M_{w} from about 1,000 g/mol to about 15,000 g/mol, and a polydispersity index (PDI) of less than 1.5. In yet another example, the thermoplastic polymer can be polystyrene or a co-polymer thereof having a M_{w} from about 1,000 g/mol to about 15,000 g/mol, and a polydispersity index (PDI) of less than 1.2. In yet another example, the thermoplastic polymer can be polystyrene or a co-polymer thereof having a M_{w} from about 1,000 g/mol to about 15,000 g/mol, and a polydispersity index (PDI) of less than 1.1.

In one aspect, the thermoplastic polymer is polystyrene or a co-polymer thereof having a M_{w} from about 15,000 g/mol to about 30,000 g/mol, and a polydispersity index (PDI) of less than 2. For example, the thermoplastic polymer can be polystyrene or a co-polymer thereof having a M_{w} from about 15,000 g/mol to about 30,000 g/mol, and a polydispersity index (PDI) of less than 1.8. In another example, the thermoplastic polymer can be polystyrene or a co-polymer thereof having a M_{w} from about 15,000 g/mol to about 30,000 g/mol, and a polydispersity index (PDI) of less than 1.5. In yet another example, the thermoplastic polymer can be polystyrene or a co-polymer thereof having a M_{w} from about 15,000 g/mol to about 30,000 g/mol, and a polydispersity index (PDI) of less than 1.2. In yet another example, the thermoplastic polymer can be polystyrene or a co-polymer thereof having a M_{w} from about 15,000 g/mol to about 30,000 g/mol, and a polydispersity index (PDI) of less than 1.1.

In one aspect, the thermoplastic polymer is polystyrene. In another aspect, the thermoplastic polymer is a co-polymer of polystyrene. Non-limiting examples of co-polymer of polystyrene include styrene-butadiene copolymer, styrene-isoprene copolymer, styrene-ethylene-butylene copolymer, styrene-N-vinylpyrrolidone copolymer, styrene-acrylonitrile copolymer, acrylonitrile-butadiene-styrene (ABS) copolymers, styrene-allyl alcohol copolymer, and styrene-maleic anhydride copolymer.

In one aspect, the thermoplastic polymer is polymethylmethacrylate or a co-polymer thereof having a M_{w} from about 500 g/mol to about 30,000 g/mol, and a polydispersity index (PDI) of less than 2. For example, the thermoplastic polymer can be polymethylmethacrylate or a co-polymer thereof having a M_{w} from about 500 g/mol to about 30,000 g/mol, and a polydispersity index (PDI) of less than 1.8. In another example, the thermoplastic polymer can be polymethylmethacrylate or a co-polymer thereof having a M_{w} from about 500 g/mol to about 30,000 g/mol, and a polydispersity index (PDI) of less than 1.5. In yet another example, the thermoplastic polymer can be polymethylmethacrylate or a co-polymer thereof having a M_{w} from about 500 g/mol to about 30,000 g/mol, and a polydispersity index (PDI) of less than 1.2. In yet another example, the thermoplastic polymer can be polymethylmethacrylate or a co-polymer thereof having a M_{w} from about 500 g/mol to about 30,000 g/mol, and a polydispersity index (PDI) of less than 1.1.

In one aspect, the thermoplastic polymer is polymethylmethacrylate or a co-polymer thereof having a M_{w} from about 1,000 g/mol to about 15,000 g/mol, and a polydispersity index (PDI) of less than 2. For example, the thermoplastic polymer can be polymethylmethacrylate or a co-polymer thereof having a M_{w} from about 1,000 g/mol to about 15,000 g/mol, and a polydispersity index (PDI) of less than 1.8. In another example, the thermoplastic polymer can be polymethylmethacrylate or a co-polymer thereof having a M_{w} from about 1,000 g/mol to about 15,000 g/mol, and a polydispersity index (PDI) of less than 1.5. In yet another example, the thermoplastic polymer can be polymethylmethacrylate or a co-polymer thereof having a M_{w} from about 1,000 g/mol to about 15,000 g/mol, and a polydispersity index (PDI) of less than 1.2. In yet another example, the thermoplastic polymer can be polymethylmethacrylate or a co-polymer thereof having a M_{w} from about 1,000 g/mol to about 15,000 g/mol, and a polydispersity index (PDI) of less than 1.1.

In one aspect, the thermoplastic polymer is polymethylmethacrylate or a co-polymer thereof having a M_{w} from about 15,000 g/mol to about 30,000 g/mol, and a polydispersity index (PDI) of less than 2. For example, the thermoplastic polymer can be polymethylmethacrylate or a co-polymer thereof having a M_{w} from about 15,000 g/mol to about 30,000 g/mol, and a polydispersity index (PDI) of less than 1.8. In another example, the thermoplastic polymer can be polymethylmethacrylate or a co-polymer thereof having a M_{w} from about 15,000 g/mol to about 30,000 g/mol, and a polydispersity index (PDI) of less than 1.5. In yet another example, the thermoplastic polymer can be polymethylmethacrylate or a co-polymer thereof having a M_{w} from about 15,000 g/mol to about 30,000 g/mol, and a polydispersity index (PDI) of less than 1.2. In yet another example, the thermoplastic polymer can be polymethylmethacrylate or a co-polymer thereof having a M_{w} from about 15,000 g/mol to about 30,000 g/mol, and a polydispersity index (PDI) of less than 1.1.

In one aspect, the thermoplastic polymer is polymethylmethacrylate. In another aspect, the thermoplastic polymer is a co-polymer of polymethylmethacrylate. Non-limiting examples of co-polymer of polymethylmethacrylate include to polymethylmethacrylate-Styrene copolymers, polymethylmethacrylate-acrylate copolymers, and copolymers of polymethylmethacrylate with polymethacrylates having pendant groups, such as one or more n-butyl or n-hexyl groups.

In one aspect, the thermoplastic polymer is polyacrylonitrile or a co-polymer thereof having a M_{w} from about 500 g/mol to about 30,000 g/mol, and a polydispersity index (PDI) of less than 2. For example, the thermoplastic polymer can be polyacrylonitrile or a co-polymer thereof having a M_{w} from about 500 g/mol to about 30,000 g/mol, and a polydispersity index (PDI) of less than 1.8. In another example, the thermoplastic polymer can be polyacrylonitrile or a co-polymer thereof having a M_{w} from about 500 g/mol to about 30,000 g/mol, and a polydispersity index (PDI) of less than 1.5. In yet another example, the thermoplastic polymer can be polyacrylonitrile or a co-polymer thereof having a M_{w} from about 500 g/mol to about 30,000 g/mol, and a polydispersity index (PDI) of less than 1.2. In yet another example, the thermoplastic polymer can be polyacrylonitrile or a co-polymer thereof having a M_{w} from about 500 g/mol to about 30,000 g/mol, and a polydispersity index (PDI) of less than 1.1.

In one aspect, the thermoplastic polymer is polyacrylonitrile or a co-polymer thereof having a M_{w} from about 1,000 g/mol to about 15,000 g/mol, and a polydispersity index (PDI) of less than 2. For example, the thermoplastic polymer can be polyacrylonitrile or a co-polymer thereof having a M_{w} from about 1,000 g/mol to about 15,000 g/mol, and a polydispersity index (PDI) of less than 1.8. In another example, the thermoplastic polymer can be polyacrylonitrile or a co-polymer thereof having a M_{w} from about 1,000 g/mol to about 15,000 g/mol, and a polydispersity index (PDI) of less than 1.5. In yet another example, the thermoplastic polymer can be polyacrylonitrile or a co-polymer thereof having a M_{w} from about 1,000 g/mol to about 15,000 g/mol, and a polydispersity index (PDI) of less than 1.2. In yet another example, the thermoplastic polymer can be polyacrylonitrile or a co-polymer thereof having a M_{w} from about 1,000 g/mol to about 15,000 g/mol, and a polydispersity index (PDI) of less than 1.1.

In one aspect, the thermoplastic polymer is polyacrylonitrile or a co-polymer thereof having a M_{w} from about 15,000 g/mol to about 30,000 g/mol, and a polydispersity index (PDI) of less than 2. For example, the thermoplastic polymer can be polyacrylonitrile or a co-polymer thereof having a M_{w} from about 15,000 g/mol to about 30,000 g/mol, and a polydispersity index (PDI) of less than 1.8. In another example, the thermoplastic polymer can be polyacrylonitrile or a co-polymer thereof having a M_{w} from about 15,000 g/mol to about 30,000 g/mol, and a polydispersity index (PDI) of less than 1.5. In yet another example, the thermoplastic polymer can be polyacrylonitrile or a co-polymer thereof having a M_{w} from about 15,000 g/mol to about 30,000 g/mol, and a polydispersity index (PDI) of less than 1.2. In yet another example, the thermoplastic polymer can be polyacrylonitrile or a co-polymer thereof having a M_{w} from about 15,000 g/mol to about 30,000 g/mol, and a polydispersity index (PDI) of less than 1.1.

In one aspect, the thermoplastic polymer is polyacrylonitrile. In another aspect, the thermoplastic polymer is a co-polymer of polyacrylonitrile. Non-limiting examples of co-polymer of polyacrylonitrile include to polyacrylonitrile-butadiene copolymer, and polyacrylonitrile-butadiene-styrene (ABS) copolymer.

In one aspect, the particle has an average particle diameter from about 0.01 μm to about 500 μm. For example, the can have an average particle diameter from about 0.01 μm to about 300 μm. In another example, the can have an average particle diameter from about 0.01 μm to about 150 μm. In yet another example, the can have an average particle diameter from about 0.01 μm to about 100 μm. In yet another example, the can have an average particle diameter from about 0.01 μm to about 80 μm. In yet another example, the can have an average particle diameter from about 0.01 μm to about 50 μm. In yet another example, the can have an average particle diameter from about 0.01 μm to about 30 μm. In yet another example, the can have an average particle diameter from about 0.01 μm to about 20 μm. In yet another example, the can have an average particle diameter from about 1 μm to about 30 μm. In yet another example, the can have an average particle diameter from about 100 μm to about 300 μm. In yet another example, the can have an average particle diameter from about 100 μm to about 500 μm.

The particle disclosed herein can be made by emulsion techniques. For example, the platinum-group catalyst and the thermoplastic polymer can be added to an oil/water system. The system can be sheared to cause micelle formation. The solvent can be removed to cause the micelles to consolidate. The micelles can be filtered, washed, and dried.

The particle disclosed herein can also be made using spray drying techniques. For example, the platinum-group catalyst and the thermoplastic polymer can be added to a solvent system. The solvent system dissolves the thermoplastic polymer. The particles can then be made by spraying the solvent system as an aerosol. The particles can be washed and dried.

Component (D) is present from 0.00001 to 20 parts by weight. For example, component (D) can be present from 0.01 to 20 parts by weight, from 0.01 to 10 parts by weight, from 0.1 to 20 parts by weight, from 1 to 20 parts by weight, from 0.1 to 15 parts by weight, from 0.1 to 10 parts by weight, from 0.00001 to 10 parts by weight, from 0.00001 to 5 parts by weight, from 3 to 8 parts by weight, from 1 to 10 parts by weight, from 5 to 15 parts by weight, or from 0.00001 to 1 parts by weight.

In one aspect, the particle disclosed herein is present in an amount effective to promote crosslinking of the curable organopolysiloxane foam-forming composition by a hydrosilylation reaction. For example, the particle disclosed herein can be present from 0.05 wt % to 5 wt % based on the total weight of the curable organopolysiloxane foam-forming composition. In another example, the particle disclosed herein can be present from 0.5 wt % to 5 wt % based on the total weight of the curable organopolysiloxane foam-forming composition. In yet another example, the particle disclosed herein can be present from 1 wt % to 5 wt % based on the total weight of the curable organopolysiloxane foam-forming composition. In yet another example, the particle disclosed herein can be present from 3 wt % to 5 wt % based on the total weight of the curable organopolysiloxane foam-forming composition. In yet another example, the particle disclosed herein can be present from 0.05 wt % to 3 wt % based on the total weight of the curable organopolysiloxane foam-forming composition. In yet another example, the particle disclosed herein can be present from 0.05 wt % to 1 wt % based on the total weight of the curable organopolysiloxane foam-forming composition. In yet another example, the particle disclosed herein can be present from 0.05 wt % to 0.5 wt % based on the total weight of the curable organopolysiloxane foam-forming composition.

v. Component (E)

Component (E) is an optional component in the curable organopolysiloxane foam-forming composition. When present, the curable organopolysiloxane foam-forming composition further comprises (E) more than 0 to 100 parts by weight of a silicone resin, wherein the silicone resin is different from component (A).

Silicone resins can be identified according to a shorthand nomenclature system known to those of ordinary skill in the art as “MDTQ” nomenclature. Under this naming system, the silicone is described according to the presence of various siloxane monomer units which make up the silicone. Briefly, the symbol M denotes the monofunctional unit (CH₃)₃SiO_{0.5}; D denotes the difunctional unit (CH₃)₂SiO; T denotes the trifunctional unit (CH₃)SiO_{1.5}; and Q denotes the quadra- or tetra-functional unit SiO₂. Primes of the unit symbols (e.g. M′, D′, T′, and Q′) denote substituents other than methyl, and must be specifically defined for each occurrence. Typical alternate substituents include groups such as vinyl, phenyls, amines, hydroxyls, etc. The molar ratios of the various units, either in terms of subscripts to the symbol indicating the total number of each type of unit in the silicone (or an average thereof) or as specifically indicated ratios in combination with molecular weight complete the description of the silicone material under the MDTQ system. Higher relative molar amounts of T, Q, T′ and/or Q′ to D, D′, M and/or M′ in a silicone resin is indicative of higher levels of crosslinking.

Suitable silicone resins in Component (E) include, but are not limited to MQ, MT, MTQ, MDT, MDTQ, MDQ, DT, DTQ, or an DQ resin. In one aspect, methyl is the silicone resin substituent. In another aspect, the silicone resin is a MQ silicone resin.

When present, component (E) is present from more than 0 to 100 parts by weight. For example, component (E) can be present from more than 0 to 90 parts by weight, from more than 0 to 80 parts by weight, from more than 0 to 70 parts by weight, from more than 0 to 60 parts by weight, from more than 0 to 50 parts by weight, from more than 0 to 40 parts by weight, from more than 0 to 30 parts by weight, from more than 0 to 20 parts by weight, from more than 0 to 10 parts by weight, from more than 0 to 5 parts by weight, from 5 to 10 parts by weight, from 5 to 20 parts by weight, from 5 to 30 parts by weight, from 5 to 40 parts by weight, from 5 to 50 parts by weight, from 5 to 60 parts by weight, from 5 to 70 parts by weight, from 5 to 80 parts by weight, from 5 to 90 parts by weight, or from 5 to 100 parts by weight.

vi. Component (F)

Component (F) is an optional component in the curable organopolysiloxane foam-forming composition. When present, the curable organopolysiloxane foam-forming composition further comprises (F) more than 0 to 150 parts by weight of a silicone base comprising a silicone polymer comprising at least one alkenyl group, wherein the silicone base is different than component (A).

A silicone base comprising a silicone polymer comprising at least one alkenyl group provides high heat resistance to the resulting cured foam. Examples of silicone polymers that comprise at least one alkenyl group include, but are not limited to, polysiloxanes having a linear structure comprising at least one alkenyl group, polysiloxanes comprising at least one alkenyl group on the end of a molecule thereof, and cyclic siloxane compounds containing at least one alkenyl group.

Non-limiting examples of polysiloxanes having a linear structure comprising at least one alkenyl group include copolymers of a dimethylsiloxane unit, methylvinylsiloxane unit and terminal trimethylsiloxy unit, copolymers of a diphenylsiloxane unit, methylvinylsiloxane unit and terminal trimethylsiloxy unit, copolymers of a methylphenylsiloxane unit, methylvinylsiloxane unit and terminal trimethylsiloxy unit, and polysiloxanes in which an end thereof is blocked with a dimethylvinylsilyl group.

Non-limiting examples of polysiloxanes comprising at least one alkenyl group on the end of the molecule thereof include the previously exemplified polysiloxanes in which the end is blocked with a dimethylalkenyl group and polysiloxanes comprising a dimethylalkenylsiloxane unit and at least one siloxane unit selected from the group consisting of SiO₂ unit, SiO_{3/2} unit and SiO unit.

Non-limiting examples of cyclic siloxane compounds containing at least one alkenyl group include 1,3,5,7-vinyl-1,3,5,7-tetramethylcyclotetrasiloxane, 1-propyl-3,5,7-trivinyl-1,3,5,7-tetramethylcyclotetrasiloxane, 1,5-divinyl-3,7-dihexyl-1,3,5,7-tetramethylcyclotetrasiloxane, 1,3,5-trivinyl-1,3,5-trimethylcyclosiloxane, 1,3,5,7,9-pentavinyl-1,3,5,7,9-pentamethylcyclosiloxane, and 1,3,5,7,9,11-hexavinyl-1,3,5,7,9,11-hexamethylcyclosiloxane.

The at least one alkenyl group may be, for example, a vinyl group, an allyl group, a butenyl group, pentenyl group, a hexenyl group, a octenyl group, cyclohexenyl group, or any combination thereof.

In one aspect, component (F) comprises silica and the silicone polymer comprising at least one alkenyl group.

Component (F) is present from more than 0 to 150 parts by weight. For example, component (F) can be present from more than 0 to 140 parts by weight, from more than 0 to 130 parts by weight, from more than 0 to 120 parts by weight, from more than 0 to 110 parts by weight, from more than 0 to 100 parts by weight, from more than 0 to 90 parts by weight, from more than 0 to 80 parts by weight, from more than 0 to 70 parts by weight from more than 0 to 60 parts by weight, from more than 0 to 50 parts by weight, from more than 0 to 40 parts by weight, from more than 0 to 30 parts by weight, from more than 0 to 20 parts by weight, from more than 0 to 10 parts by weight, from more than 0 to 5 parts by weight, from 5 to 10 parts by weight, from 10 to 20 parts by weight, from 10 to 30 parts by weight, from 10 to 40 parts by weight, from 10 to 50 parts by weight, from 10 to 60 parts by weight, from 10 to 70 parts by weight, from 10 to 80 parts by weight, from 10 to 90 parts by weight, from 10 to 100 parts by weight, from 10 to 110 parts by weight, from 10 to 120 parts by weight, from 10 to 130 parts by weight, from 10 to 140 parts by weight, or from 10 to 150 parts by weight.

vii. Filler, Treating Agent, and/or Surfactant

The filler is an optional component in the curable organopolysiloxane foam-forming composition. When present, the curable organopolysiloxane foam-forming composition further comprises from more than 0 parts to 150 parts by weight of filler.

In one aspect, the filler can be an inorganic filler. The filler can be non-reactive in the curable organopolysiloxane foam-forming composition. Non-limiting examples of fillers include silicone dioxide fillers such as, silica, fumed silica, colloidal silica, precipitated silica, crystalline quartz, and diatomaceous earth; carbon fillers such as carbon black, carbon fiber, carbon nanotubes, graphite, graphene, and reduced graphite oxides; metal oxides such as titanium dioxide, aluminum oxide, iron oxide, zinc oxide, and indium tin oxide; metals such as silver and gold; calcium carbonate; microballoon, for example a glass microballon; and boron nitride.

The fillers can be pre-treated or in-situ treated with treating agents such as silazanes (hexamethyldisilazane, divinyltetramethyldisilazane, etc.), cyclic silazanes (dimethylcyclicsilazane, 1,3,5,7-tetravinyl-1,3,5,7-tetramethylcyclotetrasilazane, etc.), chlorosilanes (trimethylchlorosilane, dimethyldichlrosilane, dimethylvinylsilane, etc.), and low molecular weight silicone fluids (octamethylcyclotetrasiloxane, decamethylcyclopentasiloxane, etc.).

The filler can be present from more than 0 parts to 150 parts by weight. For example, the filler can be present from 10 to 150 parts by weight, from 25 to 150 parts by weight, from 50 to 150 parts by weight, from 75 to 150 parts by weight, from 100 to 150 parts by weight, from 25 to 100 parts by weight, from 50 to 100 parts by weight, from 10 to 125 part by weight, from 25 to 125 parts by weight, from more than 0 to 100 parts by weight, from more than 0 to 50 parts by weight, or from more than 0 to 25 parts by weight.

A treating agent can optionally be present from more than 0 parts to 150 parts by weight. For example, the filler can be present from 10 to 150 parts by weight, from 25 to 150 parts by weight, from 50 to 150 parts by weight, from 75 to 150 parts by weight, from 100 to 150 parts by weight, from 25 to 100 parts by weight, from 50 to 100 parts by weight, from 10 to 125 part by weight, from 25 to 125 parts by weight, from more than 0 to 100 parts by weight, from more than 0 to 50 parts by weight, or from more than 0 to 25 parts by weight.

A surfactant can optionally be present from more than 0 parts to 150 parts by weight. For example, the filler can be present from 10 to 150 parts by weight, from 25 to 150 parts by weight, from 50 to 150 parts by weight, from 75 to 150 parts by weight, from 100 to 150 parts by weight, from 25 to 100 parts by weight, from 50 to 100 parts by weight, from 10 to 125 part by weight, from 25 to 125 parts by weight, from more than 0 to 100 parts by weight, from more than 0 to 50 parts by weight, or from more than 0 to 25 parts by weight. Surfactants can be of the anionic, cationic, non-ionic or amphoteric type, or mixtures thereof. Suitable anionic organic detergent surfactants include alkali metal soaps of higher fatty acids, alkyl aryl sulphonates, for example sodium dodecyl benzene sulphonate, long chain (fatty) alcohol sulphates, olefine sulphates and sulphonates, sulphated monoglycerides, sulphated esters, sulphosuccinates, alkane sulphonates, phosphate esters, alkyl isothionates, sucrose esters and fluoro-surfactants.

Suitable cationic organic detergent surfactants include alkylamine salts, quaternary ammonium salts, sulphonium salts and phosphonium salts.

Suitable non-ionic detergent surfactants include condensates of ethylene oxide with a long chain (fatty) alcohol or (fatty) acid, for example, C14-15 alcohol, condensed with 7 moles of ethylene oxide (Dobanol® 45-7), condensates of ethylene oxide with an amine or an amide, condensation products of ethylene and propylene oxides, fatty acid alkylol amide and fatty amine oxides.

Suitable amphoteric organic detergent surfactants include imidazoline compounds, alkylaminoacid salts and betaines.

viii. Component (G)

Component (G) is an optional component in the curable organopolysiloxane foam-forming composition. When component (G) is present, the curable organopolysiloxane foam-forming composition further comprises (G) more than 0 parts to 100 parts of a non-functional fluid.

A non-functional fluid may be used to adjust the physical properties of the foam (e.g. viscoelasticity, density, modulus of elasticity). Non-limiting examples of a non-functional fluids include dimethylsiloxane polymers capped at both molecular terminals with trimethylsiloxy groups, methylphenylsiloxane polymers capped at both molecular terminals with trimethylsiloxy groups, dimethylsiloxane-methylphenylsiloxane copolymers capped at both molecular terminals with trimethylsiloxy groups, methylphenylpolysiloxanes capped at both molecular terminals with trimehylsiloxy groups, dimethylsiloxane-diphenylsiloxane copolymers capped at both molecular terminals with trimethylsiloxy groups.

The non-functional fluid can be present from more than 0 parts to 100 parts by weight. For example, the non-functional fluid can be present from 1 to 100 parts by weight, from 5 to 100 parts by weight, from 10 to 100 parts by weight, from 20 to 100 parts by weight, from 30 to 100 parts by weight, from 40 to 100 parts by weight, from 50 to 100 parts by weight, from 60 to 100 parts by weight, from 70 to 100 parts by weight, from 80 to 100 parts by weight, from 90 to 100 parts by weight, from 0 to 90 parts by weight, from 0 to 80 parts by weight, from 0 to 70 parts by weight, from 0 to 60 parts by weight, from 0 to 50 parts by weight, from 0 to 40 parts by weight, from 0 to 30 parts by weight, from 0 to 20 parts by weight, from 0 to 10 parts by weight, from 1 to 50 parts by weight, from 1 to 30 parts by weight, from 1 to 20 parts by weight, from 5 to 30 parts by weight, or from 10 to 20 parts by weight.

ix. Reaction Inhibitor

The reaction inhibitor is an optional component in the curable organopolysiloxane foam-forming composition. When the reaction inhibitor is present, the curable organopolysiloxane foam-forming composition further comprises from more than 0 parts to 5 parts, such as from more than 0 parts to 10 parts, by weight of the reaction inhibitor.

A reaction inhibitor slows down and controls the reaction caused when the catalyst comes into contact with the components in the curable organopolysiloxane foam-forming composition. For example, the reaction inhibitor can interact with the catalyst to decrease the activity of the catalyst. Non-limiting examples of reaction inhibitors include acetylene alcohols such as 1-ethynyl-1-cyclohexanol, 2-methyl-3-butyn-2-ol, 2-phenyl-3-butyn-2-ol, 2-ethynylisopropanol, 2-ethynylbutan-2-ol, and 3,5-dimethyl-1-hexyn-3-ol; silylated acetylene alcohols such as trimethyl (3,5-dimethyl-1-hexyn-3-oxy) silane, methylvinylbis(3-methyl-1-butyn-3-oxy) silane, and ((1,1-dimethyl-2-propynyl)oxy)trimethylsilane; unsaturated carboxylic acid esters such as diallyl maleate, dimethyl maleate, diethylfumarate, diallyl fumarate, and bis(methoxyisopropyl) maleate; conjugated ene-yne compounds such as 2-isobutyl-1-buten-3-yne, 3,5-dimethyl-3-hexen-1-yne, 3-methyl-3-penten-1-yne, 3-methyl-3-hexen-1-yne, 1-ethynylcyclohexene, 3-ethyl-3-buten-1-yne, and 3-phenyl-3-buten-1-yne; and alkenyl group-containing cyclic siloxanes such as 1,3,5,7-tetramethyl-1,3,5,7-tetravinylcyclotetrasiloxane.

The reaction inhibitor can be present from more than 0 parts to 10 parts by weight. For example, the reaction inhibitor can be present from more than 0.5 to 10 parts by weight, from 1 to 10 parts by weight, from 3 to 10 parts by weight, from 5 to 10 parts by weight, from more than 0.5 to 8 parts by weight, from 0.5 to 6 parts by weight, or from 0.05 to 4 parts by weight.

In one aspect, the curable organopolysiloxane foam-forming composition can be a homogeneous mixture of all components present in the curable organopolysiloxane foam-forming composition. For example, the curable organopolysiloxane foam-forming composition can be a homogeneous mixture of the organopolysiloxane represented by the average unit formula: RₐSiO_{(4-a)/2}, the organopolysiloxane having at least an average of 1.5 silicon-bonded hydrogen atoms in a molecule, the foaming agent, and the particle disclosed herein. In one aspect, the particle disclosed herein can be homogeneously dispersed with the other components in the curable organopolysiloxane foam-forming composition.

The curable organopolysiloxane foam-forming composition can be made herein by mixing the components in curable organopolysiloxane foam-forming composition and by activating the catalyst by applying heat to soften or melt the thermoplastic polymer that encapsulates the catalyst in the particle.

### C. Organopolysiloxane Foam

Also disclosed herein, is an organopolysiloxane foam. The organopolysiloxane foam can be produced from the curable organopolysiloxane foam-forming composition disclosed herein.

Also disclosed is organopolysiloxane foam having a molecular weight controlled thermoplastic polymer having a T_{g} or softening temperature of at least 20° C. dispersed throughout organopolysiloxane foam, wherein the molecular weight controlled thermoplastic polymer is selected from the group consisting of:
a) polystyrene or a co-polymer thereof having a M_{w} from about 500 g/mol to about 30,000 g/mol, and a polydispersity index (PDI) of less than 2;
b) polymethylmethacrylate or a co-polymer thereof having a M_{w} from about 500 g/mol to about 30,000 g/mol, and a PDI of less than 2; or
c) polyacrylonitrile or a co-polymer thereof having a M_{w} from about 500 g/mol to about 30,000 g/mol, and a PDI of less than 2.

The molecular weight controlled thermoplastic polymer in the organopolysiloxane foam can have the properties as described elsewhere herein.

### D. Methods

Also disclosed herein, is a method of using the curable organopolysiloxane foam-forming composition disclosed herein. Disclosed herein is a method of producing an organopolysiloxane foam comprising the steps of:
a) providing the curable organopolysiloxane foam-forming composition disclosed herein; and
b) heating the curable organopolysiloxane foam-forming composition to a temperature effective to soften or melt the thermoplastic polymer to release the platinum-group catalyst, thereby promoting the reaction that produces the organopolysiloxane foam.

In one aspect, the temperature effective to soften the thermoplastic polymer is from about 30° C. to about 180° C. For example, the temperature effective to soften the thermoplastic polymer can be from about 40° C. to about 100° C. In another example, the temperature effective to soften the thermoplastic polymer is from about 60° C. to about 90° C. In another example, the temperature effective to soften the thermoplastic polymer is from about 55° C. to about 75° C. In another example, the temperature effective to soften the thermoplastic polymer is from about 75° C. to about 95° C. In another example, the temperature effective to soften the thermoplastic polymer is from about 100° C. to about 180° C. In another example, the temperature effective to soften the thermoplastic polymer is from about 80° C. to about 150° C. When the thermoplastic polymer softens, the platinum group catalyst becomes exposed to the organopolysiloxane components of the curable organopolysiloxane composition to cause the curable organopolysiloxane composition to cure.

In one aspect, the temperature effective to melt the thermoplastic polymer is from about 30° C. to about 180° C. For example, the temperature effective to melt the thermoplastic polymer can be from about 40° C. to about 100° C. In another example, temperature effective to melt the thermoplastic polymer is from about 60° C. to about 90° C. In another example, temperature effective to melt the thermoplastic polymer is from about 55° C. to about 75° C. In another example, temperature effective to melt the thermoplastic polymer is from about 75° C. to about 95° C. In another example, temperature effective to melt the thermoplastic polymer is from about 100° C. to about 180° C. In another example, temperature effective to melt the thermoplastic polymer is from about 80° C. to about 150° C. When the thermoplastic polymer melts the platinum group catalyst becomes exposed to the organopolysiloxane components of the curable organopolysiloxane composition to cause the curable organopolysiloxane composition to cure.

In one aspect, the curing of the curable organopolysiloxane foam-forming composition occurs for a period of time being from more than 0 min to 144 hours. For example, the curing of the curable organopolysiloxane foam-forming can occur for a period of time being from more than 0 min to 100 hours. In another example, the curing of the curable organopolysiloxane foam-forming can occur for a period of time being from more than 10 min to 90 hours. In yet another example, the curing of the curable organopolysiloxane foam-forming can occur for a period of time being from more than 10 min to 72 hours. In yet another example, the curing of the curable organopolysiloxane foam-forming can occur for a period of time being from more than 10 min to 48 hours. In yet another example, the curing of the curable organopolysiloxane foam-forming can occur for a period of time being from more than 10 min to 24 hours. In yet another example, the curing of the curable organopolysiloxane foam-forming can occur for a period of time being from 24 hours to 100 hours. In yet another example, the curing of the curable organopolysiloxane foam-forming can occur for a period of time being from 48 hours to 100 hours. In yet another example, the curing of the curable organopolysiloxane foam-forming can occur for a period of time being from more than 10 min to 18 hours. In yet another example, the curing of the curable organopolysiloxane foam-forming can occur for a period of time being from more than 10 min to 12 hours. In yet another example, the curing of the curable organopolysiloxane foam-forming can occur for a period of time being from more than 10 min to 6 hours. In yet another example, the curing of the curable organopolysiloxane foam-forming can occur for a period of time being from more than 10 min to 3 hours. In yet another example, the curing of the curable organopolysiloxane foam-forming can occur for a period of time being from more than 10 min to 1 hour. In yet another example, the curing of the curable organopolysiloxane foam-forming can occur for a period of time being from more than 12 hours to 72 hours. In yet another example, the curing of the curable organopolysiloxane foam-forming can occur for a period of time being from more than 24 hours to 72 hours.

In one aspect, providing the curable organopolysiloxane foam-forming comprises applying the curable organopolysiloxane foam-forming to a surface. In one aspect, the surface can be a surface located indoors. In another aspect, the surface can be in need of repair.

In one aspect, providing the curable organopolysiloxane foam-forming comprises molding, extruding, or calendaring the curable organopolysiloxane foam-forming. For example, providing the curable organopolysiloxane foam-forming can comprise molding. In another aspect, providing the curable organopolysiloxane foam-forming can comprise extruding. In another aspect, providing the curable organopolysiloxane foam-forming can comprise calendaring.

### E. Aspects

In view of the disclosure herein below are described certain more particularly described aspects of the inventions. These particularly recited aspects should not however be interpreted to have any limiting effect on any different claims containing different or more general teachings described herein, or that the “particular” aspects are somehow limited in some way other than the inherent meanings of the language and formulas literally used therein.

Aspect 1: A curable organopolysiloxane foam-forming composition comprising: (A) 100 parts by weight of an organopolysiloxane represented by the average unit formula: RₐSiO_{(4-a)/2} wherein, R is a substituted or unsubstituted monovalent hydrocarbon group, and “a” is a number from 1.0 to 2.4, and having at least an average of 1.5 alkenyl groups in a molecule; (B) from 1 to 70 parts, such as from 3 to 70 parts, by weight an organopolysiloxane having at least an average of 1.5 silicon-bonded hydrogen atoms in a molecule; (C) from 0.1 to 50 parts of a blowing agent; and (D) from 0.00001 to 20 parts of a particle comprising: i. a platinum-group catalyst; and ii. a molecular weight controlled thermoplastic polymer having a T_{g} or softening temperature of at least 20° C. selected from the group consisting of: 1. polystyrene or a co-polymer thereof having a M_{w} from about 500 g/mol to about 30,000 g/mol, and a polydispersity index (PDI) of less than 2; 2. polymethylmethacrylate or a co-polymer thereof having a M_{w} from about 500 g/mol to about 30,000 g/mol, and a PDI of less than 2; and 3. polyacrylonitrile or a co-polymer thereof having a M_{w} from about 500 g/mol to about 30,000 g/mol, and a PDI of less than 2; wherein the platinum-group catalyst is fully encapsulated within the thermoplastic polymer.

Aspect 2: The curable organopolysiloxane foam-forming composition of aspect 1, wherein the curable organopolysiloxane foam-forming composition further comprises from more than 0 parts to 5 parts, such as from more than 0 parts to 10 parts, of a reaction inhibitor.

Aspect 3: The curable organopolysiloxane foam-forming composition of aspect 1 or 2, wherein the curable organopolysiloxane foam-forming composition further comprises from more than 0 parts to 150 parts of a filler.

Aspect 4: The curable organopolysiloxane foam-forming composition of aspect 3, wherein the filler is an inorganic filler.

Aspect 5: The curable organopolysiloxane foam-forming composition of any one of aspects 1-4, wherein the organopolysiloxane in component (A) comprises at least two organopolysiloxanes having different molecular weights.

Aspect 6: The curable organopolysiloxane foam-forming composition of any one of aspects 1-5, wherein the curable organopolysiloxane foam-forming composition further comprises: (E) more than 0 to 100 parts by weight of a silicone resin, wherein the silicone resin is different than component (A).

Aspect 7: The curable organopolysiloxane foam-forming composition of any one of aspects 1-6, wherein the curable organopolysiloxane foam-forming composition further comprises: (F) more than 0 to 150 parts by weight of a silicone base comprising a silicone polymer comprising at least one alkenyl group, wherein the silicone base is different than component (A).

Aspect 8: The curable organopolysiloxane foam-forming composition of aspect 6 or 7, wherein the silicone resin is a MQ silicone resin.

Aspect 9: The curable organopolysiloxane foam-forming composition of aspect 6 or 7, wherein E is present from more than 0 to 60 parts by weight.

Aspect 10: The curable organopolysiloxane foam-forming composition of aspect 6 or 7, wherein the silicone base comprises silica and the silicone polymer comprising at least one alkenyl group.

Aspect 11: The curable organopolysiloxane foam-forming composition of aspect 7, wherein F is present from 10 to 40 parts by weight.

Aspect 12: The curable organopolysiloxane foam-forming composition of aspect 6 or 7, wherein E is present from 5 to 40 parts by weight.

Aspect 13: The curable organopolysiloxane foam-forming composition of any one of aspects 1-12, wherein the organopolysiloxane in part (B) is present from 5 to 40 parts by weight.

Aspect 14: The curable organopolysiloxane foam-forming composition of any one of aspects 1-13, wherein the blowing agent is present from 5 to 40 parts by weight.

Aspect 15: The curable organopolysiloxane foam-forming composition of any one of aspects 1-14, wherein the curable organopolysiloxane foam-forming composition further comprises: more than 0 parts to 100 parts of a non-functional fluid.

Aspect 16: The curable organopolysiloxane foam-forming composition of any one of aspects 1-15, wherein the particle is present from 0.01 to 10 parts by weight.

Aspect 17: The curable organopolysiloxane foam-forming composition of any one of aspects 1-16, wherein the thermoplastic polymer is polystyrene or a co-polymer thereof having a M_{w} from about 500 g/mol to about 30,000 g/mol, and a polydispersity index (PDI) of less than 2.

Aspect 18: The curable organopolysiloxane foam-forming composition of aspect 17, wherein the polystyrene or a co-polymer thereof has a M_{w} from about 1,000 g/mol to about 15,000 g/mol.

Aspect 19: The curable organopolysiloxane foam-forming composition of aspect 17 or 18, wherein the polystyrene or a co-polymer thereof has a PDI of less than 1.5.

Aspect 20: The curable organopolysiloxane foam-forming composition of aspect 17 or 18, wherein the polystyrene or a co-polymer thereof has a PDI of less than 1.2.

Aspect 21: The curable organopolysiloxane foam-forming composition of any one of aspects 1-20, wherein the thermoplastic polymer is polymethylmethacrylate or a co-polymer thereof having a M_{w} from about 500 g/mol to about 30,000 g/mol, and a polydispersity index (PDI) of less than 2.

Aspect 22: The curable organopolysiloxane foam-forming composition of any one of aspects 1-21, wherein the polymethylmethacrylate or a co-polymer thereof has a M_{w} from about 1,000 g/mol to about 15,000 g/mol.

Aspect 23: The curable organopolysiloxane foam-forming composition of aspect 22, wherein the polymethylmethacrylate or a co-polymer thereof has a PDI of less than 1.5.

Aspect 24: The curable organopolysiloxane foam-forming composition of aspect 22, wherein the polymethylmethacrylate or a co-polymer thereof has a PDI of less than 1.2.

Aspect 25: The curable organopolysiloxane foam-forming composition of any one of aspects 1-24, wherein the thermoplastic polymer is polyacrylonitrile or a co-polymer thereof having a M_{w} from about 500 g/mol to about 30,000 g/mol, and a polydispersity index (PDI) of less than 2.

Aspect 26: The curable organopolysiloxane foam-forming composition of aspect 25, wherein the polyacrylonitrile or a co-polymer thereof has a M_{w} from about 1,000 g/mol to about 15,000 g/mol.

Aspect 27: The curable organopolysiloxane foam-forming composition of aspect 25, wherein the polyacrylonitrile or a co-polymer thereof has a PDI of less than 1.5.

Aspect 28: The curable organopolysiloxane foam-forming composition of aspect 25, wherein the polyacrylonitrile or a co-polymer thereof has a PDI of less than 1.2.

Aspect 29: The curable organopolysiloxane foam-forming composition of any one of aspects 1-28, wherein the particle has an average particle diameter from about 0.01 μm to about 500 μm.

Aspect 30: The curable organopolysiloxane foam-forming composition of any one of aspects 1-29, wherein the particle comprises from about 0.01 wt % to about 50 wt % of the platinum-group catalyst.

Aspect 31: The curable organopolysiloxane foam-forming composition of any one of aspects 1-30, wherein the curable organopolysiloxane foam-forming composition is a one-part curable organopolysiloxane foam-forming composition.

Aspect 32: The curable organopolysiloxane foam-forming composition of any one of aspects 1-30, wherein the curable organopolysiloxane foam-forming composition is a two-part curable organopolysiloxane foam-forming composition.

Aspect 33: The curable organopolysiloxane foam-forming composition of any one of aspects 1-32, wherein component (C) is present in an amount such that a quantity of silicon-bonded hydrogen atoms in component (C) is from 0.05 to 20 mol per 1 mol of alkenyl groups in component (A).

Aspect 34: The curable organopolysiloxane foam-forming composition of any one of aspects 1-33, wherein component (E) is present in an amount effective to promote crosslinking of the curable organopolysiloxane composition by a hydrosilylation reaction upon release of the platinum-group catalyst.

Aspect 35: The curable organopolysiloxane foam-forming composition of any one of aspects 1-34, wherein the curable organopolysiloxane foam-forming composition is a homogenous composition.

Aspect 36: The curable organopolysiloxane foam-forming composition of any one of aspects 1-35, wherein the molecular weight controlled thermoplastic polymer having a T_{g} or softening temperature from 30° C. to 180° C.

Aspect 37: The curable organopolysiloxane foam-forming composition of any one of aspects 1-35, wherein the molecular weight controlled thermoplastic polymer having a T_{g} or softening temperature from 55° C. to 75° C.

Aspect 38: The curable organopolysiloxane foam-forming composition of any one of aspects 1-35, wherein the molecular weight controlled thermoplastic polymer having a T_{g} or softening temperature from 75° C. to 95° C.

Aspect 39: The curable organopolysiloxane foam-forming composition of any one of aspects 1-38, wherein the curable organopolysiloxane foam-forming composition comprises: (A) 100 parts by weight of an organopolysiloxane represented by the average unit formula: RₐSiO_{(4-a)/2} wherein, R is a substituted or unsubstituted monovalent hydrocarbon group, and “a” is a number from 1.0 to 2.4, and having at least an average of 1.5 alkenyl groups in a molecule; (B) from 10 to 30 parts by weight an organopolysiloxane having at least an average of 1.5 silicon-bonded hydrogen atoms in a molecule; (C) from 5 to 20 parts of a blowing agent; (D) from 0.05 to 8 parts of a particle comprising: i. a platinum-group catalyst; and ii. a molecular weight controlled thermoplastic polymer having a T_{g} or softening temperature of at least 20° C. selected from the group consisting of: 1. polystyrene or a co-polymer thereof having a M_{w} from about 500 g/mol to about 30,000 g/mol, and a polydispersity index (PDI) of less than 2; 2. polymethylmethacrylate or a co-polymer thereof having a M_{w} from about 500 g/mol to about 30,000 g/mol, and a PDI of less than 2; and 3. polyacrylonitrile or a co-polymer thereof having a M_{w} from about 500 g/mol to about 30,000 g/mol, and a PDI of less than 2; wherein the platinum-group catalyst is fully encapsulated within the thermoplastic polymer; (E) more than 0 to 60 parts by weight of a silicone resin, wherein the silicon resin is different than component (A); and (G) more than 0 to 100 parts of a non-functional fluid.

Aspect 40: The curable organopolysiloxane foam-forming composition of any one of aspects 1-39, wherein the curable organopolysiloxane foam-forming composition comprises: (A) 100 parts by weight of an organopolysiloxane represented by the average unit formula: RₐSiO_{(4-a)/2} wherein, R is a substituted or unsubstituted monovalent hydrocarbon group, and “a” is a number from 1.0 to 2.4, and having at least an average of 1.5 alkenyl groups in a molecule; (B) from 5 to 30 parts by weight an organopolysiloxane having at least an average of 1.5 silicon-bonded hydrogen atoms in a molecule; (C) from 0.1 to 50 parts of a blowing agent; and (D) from 0.05 to 8 parts of a particle comprising: i. a platinum-group catalyst; and ii. a molecular weight controlled thermoplastic polymer having a T_{g} or softening temperature of at least 20° C. selected from the group consisting of: 1. polystyrene or a co-polymer thereof having a M_{w} from about 500 g/mol to about 30,000 g/mol, and a polydispersity index (PDI) of less than 2; 2. polymethylmethacrylate or a co-polymer thereof having a M_{w} from about 500 g/mol to about 30,000 g/mol, and a PDI of less than 2; and 3. polyacrylonitrile or a co-polymer thereof having a M_{w} from about 500 g/mol to about 30,000 g/mol, and a PDI of less than 2; wherein the platinum-group catalyst is fully encapsulated within the thermoplastic polymer; (F) 10 to 40 parts by weight of a silicone base comprising a silicone polymer comprising at least one alkenyl group, wherein the silicone base is different than component (A); and (G) more than 0 to 100 parts of a non-functional fluid.

Aspect 41: A method or producing a organopolysiloxane foam comprising the steps of: a) providing the curable organopolysiloxane foam-forming composition of any one of aspects 1-40 or 51-52; and b) heating the curable organopolysiloxane foam-forming composition to a temperature effective to soften or melt the thermoplastic polymer to release the platinum-group catalyst, thereby promoting the reaction that produces the organopolysiloxane foam.

Aspect 42: The method of aspect 41, wherein the temperature effective to soften or melt the thermoplastic polymer is from about 30° C. to about 180° C.

Aspect 43: The method of aspect 41, wherein the temperature effective to soften or melt the thermoplastic polymer is from about 55° C. to about 75° C.

Aspect 44: The method of aspect 41, wherein the temperature effective to soften or melt the thermoplastic polymer is from about 75° C. to about 95° C.

Aspect 45: The method of any one of aspects 41-44, wherein the curing of the curable organopolysiloxane foam-forming composition occurs for a period of time being from more than 0 minutes to 144 hours.

Aspect 46: The method of any one of aspects 41-45, wherein providing the curable organopolysiloxane composition comprises applying the curable organopolysiloxane foam-forming composition to a surface.

Aspect 47: The method of any one of aspects 41-46, wherein providing the curable organopolysiloxane foam-forming composition comprises molding, extruding, or calendaring the curable organopolysiloxane composition.

Aspect 48: An organopolysiloxane foam having a molecular weight controlled thermoplastic polymer having a T_{g} or softening temperature of at least 20° C. dispersed throughout organopolysiloxane foam, wherein the molecular weight controlled thermoplastic polymer is selected from the group consisting of: a) polystyrene or a co-polymer thereof having a M_{w} from about 500 g/mol to about 30,000 g/mol, and a polydispersity index (PDI) of less than 2; b) polymethylmethacrylate or a co-polymer thereof having a M_{w} from about 500 g/mol to about 30,000 g/mol, and a PDI of less than 2; or c) polyacrylonitrile or a co-polymer thereof having a M_{w} from about 500 g/mol to about 30,000 g/mol, and a PDI of less than 2.

Aspect 49: The organopolysiloxane foam of aspect 48, wherein the organopolysiloxane foam is produced from the curable organopolysiloxane foam-forming composition of any one of aspects 1-40 or 51-52.

Aspect 50: The curable organopolysiloxane foam-forming composition of any one of aspects 1-40, wherein the organopolysiloxane in (A) is an alkenyl-terminated organopolysiloxane, an alkenyl-pendant organopolysiloxane, or an alkenyl-terminated and alkenyl-pendant organopolysiloxane.

Aspect 51: The curable organopolysiloxane foam-forming composition of any one of aspects 1-40 and 51, wherein the organopolysiloxane in (B) is a hydride-terminated organopolysiloxane, a hydride-pendant organopolysiloxane, or a hydride-terminated and hydride-pendant organopolysiloxane.

### F. Examples

The following examples are put forth so as to provide those of ordinary skill in the art with a complete disclosure and description of how the compounds, compositions, articles, devices, and/or methods described and aspected herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Provided herein are examples which show the preparation of non-limiting exemplary particles disclosed herein using molecular weight controlled polystyrene (PS) and molecular weight controlled poly(methyl methacrylate) (PMMA). Both an emulsion approach and a spray drying approach were used to prepare encapsulated Pt particles. The two approaches are identical for the purpose of particle preparation, and should not be limited to specific thermoplastic polymers. Example 1 and 2 are the preparation of encapsulated Pt particles using molecular weight controlled PS. Example 3 is the preparation of encapsulated Pt particles using molecular weight controlled PMMA via a spray drying process.

### i. Example 1 (Encapsulated Pt Sample A Using Molecular Weight Controlled PS)

A flask was filled with 400 g of methylene chloride, then charged with 15 g of low molecular weight PS (M_{w}=1800 Dalton, PDI=1.04). The solution was stirred using a magnetic stirrer until the polystyrene dissolved, then 3.0 g of Karstedt's catalyst in isopropyl alcohol solution (Pt content of ~3 wt %) was charged in the solution and mixed until homogenous. In a separate flask filled with 600 g deionized water, 15 g of polyvinyl alcohol (PVA) was charged and mixed until the solution became visibly clear. Into a 3-neck, 12 L flask equipped with an air-driven stirring rod, thermocouple, condenser, and heating mantle, 350 mL of the PVA solution and 200 mL of deionized water were charged. The stir rod was activated, followed by a drip feed of 180 mL of the above methylene chloride solution. After the addition, 900 mL of deionized water was charged into the emulsion mixture. Nitrogen (N₂) purging (2 liters per minute) was then applied to the flask, and the mixture was gradually heated to 40° C. within 4 hours and kept for another 6 hours with N₂ purging. The final mixture was milky with microparticles precipitated at flask bottom. The microparticles were then isolated by centrifugation (3500 rpm), washed by isopropyl alcohol and deionized water, and finally dried under vacuum at room temperature.

### ii. Example 2 (Encapsulated Pt Sample B Using Molecular Weight Controlled PS)

The same process as described in Example 1 was used but with a different molecular weight polystyrene. A flask was filled with 400 g of methylene chloride, then charged with 15 g of low molecular weight PS (M_{w}=4000 Dalton, PDI=1.04). The solution was stirred using a magnetic stirrer until the polystyrene dissolved, then 3.0 g of Karstedt's catalyst in isopropyl alcohol solution (Pt content of ~3 wt %) was charged in the solution and mixed until homogenous. In a separate flask filled with 600 g deionized water, 15 g of PVA was charged and mixed till the solution became visibly clear. Into a 3-neck, 12 L flask equipped with an air-driven stirring rod, thermocouple, condenser, and heating mantle, 350 mL of the PVA solution and 200 mL of deionized water were charged. The stir rod was activated, followed by a drip feed of 180 mL of the above methylene chloride solution. After the addition, 900 mL of deionized water was charged into the emulsion mixture. N₂ purging (2 liters per minute) was then applied to the flask, and the mixture was gradually heated to 40° C. within 4 hours and kept for another 6 hours with N₂ purging. The final mixture was milky with microparticles precipitated at flask bottom. The microparticles were then isolated by centrifugation (3500 rpm), washed by isopropyl alcohol and deionized water, and finally dried under vacuum at room temperature.

### iii. Example 3 (Encapsulated Pt Sample C Using Conventional PS)

The same process as described in Example 1 was used but with a polystyrene that has a molecular weight and PDS outside the scope of the particles disclosed herein. A flask was filled with 400 g of methylene chloride, then charged with 15 g of conventional PS (M_{w}=350 k Dalton, PDI=2.2). The solution was stirred using a magnetic stirrer until the polystyrene dissolved, then 3.0 g of Karstedt's catalyst in isopropyl alcohol solution (Pt content of ~3 wt %) was charged in the solution and mixed until homogenous. In a separate flask filled with 600 g deionized water, 15 g of PVA was charged and mixed till the solution became visibly clear. Into a 3-neck, 12 L flask equipped with an air-driven stirring rod, thermocouple, condenser, and heating mantle, 350 mL of the PVA solution and 200 mL of deionized water were charged. The stir rod was activated, followed by a drip feed of 180 mL of the above methylene chloride solution. After the addition, 900 mL of deionized water was charged into the emulsion mixture. N₂ purging (2 liters per minute) was then applied to the flask, and the mixture was gradually heated to 40° C. within 4 hours and kept for another 6 hours with N₂ purging. The final mixture was milky with microparticles precipitated at flask bottom. The microparticles were then isolated by centrifugation (3500 rpm), washed by isopropyl alcohol and deionized water, and finally dried under vacuum at room temperature.

### iv. Example 4. Silicone Foam Composition Using Catalyst Sample A

The encapsulated catalyst of Sample A from Example 1 was tested in a silicone foam composition comprising a polydimethylsiloxane (PDMS) blocked with a dimethylvinylsiloxy radical at the two ends with a viscosity of 100,000 cP at 25° C. (32.3 wt %), a polydimethylsiloxane (PDMS) blocked with a dimethylvinylsiloxy radical at the two ends with a viscosity of 35,000 cP at 25° C. (33.1 wt %), a silicone base (14.5 wt %), a polymethylhydrogensiloxane (10-45 cSt) crosslinker (11.2 wt %), encapsulated Pt catalyst (2.0 wt %), and pentanediol blowing agent (6.7 wt %). The above-mentioned silicone base is composed of a dimethylvinylsiloxy-endblocked polydimethylsiloxane (4 k cP, 73 wt %) and a fumed silica (surface area of 200 m²/g, 25 wt %) treated with hexamethyldisilazane (2 wt %). The homogeneously-mixed above composition can be packaged in two-parts. PART A typically contains the PDMS polymers, the silicone base, a bowling agent, and catalyst A, and PART B typically contains the PDMS polymers, the silicone base, and the crosslinker. The composition can also be packaged in one-part which contains all above ingredients. The resulting composition had a pot life of more than 3 weeks at 40° C. The composition was cured at 65° C., 85° C., 100° C. and 150° C. for 20 minutes, respectively. It was partially cured at 65° C., but completely cured at 85° C., 100° C. and 150° C. into a silicone foam having uniform fine cells with a diameter around 1 mm and less.

### v. Example 5. Silicone Foam Composition Using Catalyst Sample B

The encapsulated catalyst of Sample B from Example 2 was tested in a silicone foam composition comprising a polydimethylsiloxane (PDMS) blocked with a dimethylvinylsiloxy radical at the two ends with a viscosity of 100,000 cP at 25° C. (32.3 wt %), a polydimethylsiloxane (PDMS) blocked with a dimethylvinylsiloxy radical at the two ends with a viscosity of 35,000 cP at 25° C. (33.1 wt %), a silicone base (14.5 wt %), a polymethylhydrogensiloxane (10-45 cSt) crosslinker (11.2 wt %), encapsulated Pt catalyst (2.0 wt %), and pentanediol blowing agent (6.7 wt %). The above-mentioned silicone base is composed of a dimethylvinylsiloxy-endblocked polydimethylsiloxane (4 k cP, 73 wt %) and a fumed silica (surface area of 200 m²/g, 25 wt %) treated with hexamethyldisilazane (2 wt %). The homogeneously-mixed above composition can be packaged in two-part in which PART A typically contains the PDMS polymers, the silicone base, a bowling agent, and catalyst A, and in which PART B typically contains the PDMS polymers, the silicone base, and the crosslinker. The composition can also be packaged in one-part which contains all above ingredients. The resulting composition had a pot life of more than 3 weeks at 40° C. The composition was cured at 65° C., 85° C. 100° C. and 150° C. for 20 minutes, respectively. It was not cured at 65° C., but completely cured at 85° C., 100° C. and 150° C. into a silicone foam having uniform fine cells with a diameter around 1 mm.

### vi. Example 6. Silicone Foam Composition Using Catalyst Sample C

The encapsulated catalyst of Sample C from Example 3 was tested in a silicone foam composition comprising a polydimethylsiloxane (PDMS) blocked with a dimethylvinylsiloxy radical at the two ends with a viscosity of 100,000 cP at 25° C. (32.3 wt %), a polydimethylsiloxane (PDMS) blocked with a dimethylvinylsiloxy radical at the two ends with a viscosity of 35,000 cP at 25° C. (33.1 wt %), a silicone base (14.5 wt %), a polymethylhydrogensiloxane (10-45 cSt) crosslinker (11.2 wt %), encapsulated Pt catalyst (2.0 wt %), and pentanediol blowing agent (6.7 wt %). The above-mentioned silicone base is composed of a dimethylvinylsiloxy-endblocked polydimethylsiloxane (4 k cP, 73 wt %) and a fumed silica (surface area of 200 m²/g, 25 wt %) treated with hexamethyldisilazane (2 wt %). The homogeneously-mixed above composition can be packaged in two-part in which PART A typically contains the PDMS polymers, the silicone base, a bowling agent, and Sample A, and in which PART B typically contains the PDMS polymers, the silicone base, and the crosslinker. The composition can also be packaged in one-part which contains all above ingredients. The resulting composition had a pot life of more than 3 weeks at 40° C. The composition was cured at 65° C., 85° C., 100° C. and 150° C. for 20 minutes, respectively. It was not cured at 65° C. and 85° C., partially cured at 100° C., and completely cured at 150° C. into a silicone foam having uniform fine cells with a diameter around 1 mm.

TABLE 1

| | % Cured | | |
|---|---|---|---|
| | Sample A | Sample B | Sample C |
| 65° C. | <50% | uncured | uncured |
| 85° C. | 100% | 100% | uncured |
| 100° C. | 100% | 100% | <50% |
| 150° C. | 100% | 100% | 100% |

The encapsulated catalyst was able to be used in a silicone foam system (examples 4-6) to drive a foaming reaction at various temperatures ranging from 65° C. to 150° C. The encapsulated catalyst successfully prevents curing and hydrogen formation at room temperature for all three variations (Samples A-C)), and the temperature at which the material cures distinctly differs between each catalyst, as listed in Table 1, with Sample A curing at the lowest temperature and catalyst C curing at the highest temperature of the temperatures tested.

It will be apparent to those skilled in the art that various modifications and variations can be made in the present invention without departing from the scope or spirit of the invention. Other aspects of the invention will be apparent to those skilled in the art from consideration of the specification and practice of the invention disclosed herein. It is intended that the specification and examples be considered as exemplary only, with a true scope and spirit of the invention being indicated by the following claims.

1. A curable organopolysiloxane foam-forming composition comprising:
(A) 100 parts by weight of an organopolysiloxane represented by the average unit formula: 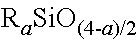
wherein, R is a substituted or unsubstituted monovalent hydrocarbon group, and “a” is a number from 1.0 to 2.4, and having at least an average of 1.5 alkenyl groups in a molecule;
(B) from 1 to 70 parts by weight an organopolysiloxane having at least an average of 1.5 silicon-bonded hydrogen atoms in a molecule;
(C) from 0.1 to 50 parts by weight of a blowing agent; and
(D) from 0.00001 to 20 parts by weight of a particle comprising:
i. a platinum-group catalyst; and
ii. a molecular weight controlled thermoplastic polymer having a T_{g} or softening temperature of at least 20° C. selected from the group consisting of:
1. polystyrene or a co-polymer thereof having a M_{w} from about 500 g/mol to about 30,000 g/mol, and a polydispersity index (PDI) of less than 2;
2. polymethylmethacrylate or a co-polymer thereof having a M_{w} from about 500 g/mol to about 30,000 g/mol, and a PDI of less than 2; and
3. polyacrylonitrile or a co-polymer thereof having a M_{w} from about 500 g/mol to about 30,000 g/mol, and a PDI of less than 2:
wherein the platinum-group catalyst is fully encapsulated within the thermoplastic polymer.

2. The curable organopolysiloxane foam-forming composition of claim 1, wherein the organopolysiloxane in (A) is an alkenyl-terminated organopolysiloxane, an alkenyl-pendant organopolysiloxane, or an alkenyl-terminated and alkenyl-pendant organopolysiloxane.

3. The curable organopolysiloxane foam-forming composition of claim 1, wherein the organopolysiloxane in (B) is a hydride-terminated organopolysiloxane, a hydride-pendant organopolysiloxane, or a hydride-terminated and hydride-pendant organopolysiloxane.

4. The curable organopolysiloxane foam-forming composition of claim 1, wherein the curable organopolysiloxane foam-forming composition further comprises from more than 0 parts to 5 parts by weight of a reaction inhibitor.

5. The curable organopolysiloxane foam-forming composition of claim 1, wherein the curable organopolysiloxane foam-forming composition further comprises from more than 0 parts to 150 parts by weight of a filler, a treating agent, or a surfactant, or a combination thereof.

6. The curable organopolysiloxane foam-forming composition of claim 5, wherein the filler is an inorganic filler.

7. The curable organopolysiloxane foam-forming composition of claim 1, wherein the organopolysiloxane in part (B) is present from 5 to 40 parts by weight.

8. The curable organopolysiloxane foam-forming composition of claim 1, wherein the blowing agent is present from 5 to 40 parts by weight.

9. The curable organopolysiloxane foam-forming composition of claim 1, wherein the particle is present from 0.01 to 10 parts by weight.

10. The curable organopolysiloxane foam-forming composition of claim 1, wherein the thermoplastic polymer is polystyrene or a co-polymer thereof having a M_{w} from about 500 g/mol to about 30,000 g/mol, and a polydispersity index (PDI) of less than 2.

11. The curable organopolysiloxane foam-forming composition of claim 10, wherein the polystyrene or a co-polymer thereof has a M_{w} from about 500 g/mol to about 15,000 g/mol and a PDI of less than 1.2.

12. The curable organopolysiloxane foam-forming composition of claim 1, wherein the thermoplastic polymer is polymethylmethacrylate or a co-polymer thereof having a M_{w} from about 500 g/mol to about 30,000 g/mol, and a polydispersity index (PDI) of less than 2.

13. The curable organopolysiloxane foam-forming composition of claim 12, wherein the polymethylmethacrylate or a co-polymer thereof has a M_{w} from about 500 g/mol to about 15,000 g/mol and a PDI of less than 1.2.

14. The curable organopolysiloxane foam-forming composition of claim 1, wherein the thermoplastic polymer is polyacrylonitrile or a co-polymer thereof having a M_{w} from about 500 g/mol to about 30,000 g/mol, and a polydispersity index (PDI) of less than 2.

15. The curable organopolysiloxane foam-forming composition of claim 14, wherein the polyacrylonitrile or a co-polymer thereof has a M_{w} from about 500 g/mol to about 15,000 g/mol and a PDI of less than 1.2.

16. The curable organopolysiloxane foam-forming composition of claim 1, wherein the particle has an average particle diameter from about 0.01 μm to about 100 μm.

17. The curable organopolysiloxane foam-forming composition of claim 1, wherein the particle comprises from about 0.01 wt % to about 20 wt % of the platinum-group catalyst.

18. The curable organopolysiloxane foam-forming composition of claim 1, wherein the curable organopolysiloxane foam-forming composition is a one-part curable organopolysiloxane foam-forming composition.

19. The curable organopolysiloxane foam-forming composition of claim 1, wherein the curable organopolysiloxane foam-forming composition is a two-part curable organopolysiloxane foam-forming composition.

20. The curable organopolysiloxane foam-forming composition of claim 1, wherein the curable organopolysiloxane foam-forming composition is a homogenous composition.

21. The curable organopolysiloxane foam-forming composition of claim 1, wherein the molecular weight controlled thermoplastic polymer having a T_{g} or softening temperature from 30° C. to 120° C.

22. A method or producing an organopolysiloxane foam comprising the steps of:
a) providing the curable organopolysiloxane foam-forming composition of claim 1; and
b) heating the curable organopolysiloxane foam-forming composition to a temperature effective to soften or melt the thermoplastic polymer to release the platinum-group catalyst, thereby promoting the reaction that produces the organopolysiloxane foam.

23. (canceled)

24. (canceled)
